(19) United States
(12) Patent Application Publication
(10) Pub. No.: US 2017/0206510 A1
(43) Pub. Date: Jul. 20, 2017

(54) SPATIALLY-KEYED, CONSOLIDATED-DATA-CONTROLLED APPARATUS AND METHOD

(71) Applicant: AZTECA SYSTEMS, LLC, Sandy, UT (US)

(72) Inventors: Carl Horton, Draper, UT (US); Jiajun Liu, Sandy, UT (US); Brian Haslam, Sandy, UT (US); Becky Tamashasky, South Bend, IN (US); Randall Sutton, West Jordan, UT (US); Sheldon Bagley, Draper, UT (US)

(21) Appl. No.: 15/458,782

(22) Filed: Mar. 14, 2017

Related U.S. Application Data
(63) Continuation-in-part of application No. 14/285,419, filed on May 22, 2014.
(60) Provisional application No. 61/827,525, filed on May 24, 2013.
(60) Provisional application No. 62/307,987, filed on Mar. 14, 2016.

(51) Int. Cl. G06Q 10/00; G06Q 10/06

(52) U.S. Cl. CPC G06Q 10/20; G06Q 10/063118; G06Q 10/06313

(57) ABSTRACT

Methods and apparatus inspecting, maintaining, repairing, and replacing infrastructure assets, including any and all physical apparatus, devices, and objects therein, rely on both internal data analyzed for components as assets, but also scoring them for actual condition, by incorporating analyses of maintenance and repair data on operations improving lifetimes. Prediction modeling of lifetimes remaining originates from analysis of data originating from manufacturer testing, expert systems, similitude with external components and systems, which may be compared to lifetimes analyzed for actual assets in order to do servicing from inspection, maintenance, and repair, through replacement.

### RELATED APPLICATIONS

This patent application is a continuation in part of co-pending U.S. patent application Ser. No. 14/285,419, filed May 22, 2014 and entitled INTEGRATED MAINTENANCE SCORING APPARATUS AND METHOD, which claims the benefit of U.S. Provisional Patent Application No. 61/827,525, filed May 24, 2013 and entitled INTEGRATED MAINTENANCE SCORING APPARATUS AND METHOD; this application also claims the benefit of co-pending U.S. Provisional Patent Application No. 62/307,987, filed Mar. 14, 2016 and entitled INTEGRATED-CONDITION-PREDICTION-BASED MAINTENANCE AND REPAIR APPARATUS AND METHOD; all of the foregoing are hereby incorporated herein by reference.

### BACKGROUND

1. Field of the Invention

This invention relates to control of hardware systems, and, more particularly, to novel systems and methods for minimizing data transfer requirements to implement control.

2. Background Art

The term “big data” may not be well defined, but acknowledges an ability to collect much more data than can be readily processed, transmitted, stored, understood, or some combination thereof. Data collected during any period of “real time” may still require months of programming, mining, and study to determine its meaning. Meaning reflects some reality requiring action at some point. Action is a major fact of life, a major requirement on persons, and perhaps the entire purpose of machinery, equipment, computers, and so forth.

Machinery is typically visible, accessible, and comparatively smaller than city infrastructure. In contrast, infrastructure, such as the infrastructure existing within and beneath, as well as overhead in, a city is difficult to monitor. Waiting for failure is expensive, inconvenient, and irresponsible. Predicting it accurately enough for timely intervention is difficult. Data is sparse, irregular, and largely uncontrolled (e.g., anecdotal; too many uncontrolled variables; different variables in each case). Therefore, information, based on that data can hardly be reliable. So, decisions are not fully informed.

On the other hand, this creates a dilemma, a control problem. Machinery, equipment, services, and all resources generally must be controlled. They need to be controlled efficiently and cost effectively. In infrastructure servicing, the tools are available and subject to control. The knowledge, information, or basic data may be lacking to implement proper control over those tools and resources.

It would be an advance in the art to create a system improve basic data, improve information content of data, and timely provide knowledge at a bandwidth and data rate useful to machine, mankind, and processors.

It would be an advance in the art to provide improved methods for maintaining, repairing, rebuilding, and replacing equipment and other infrastructure assets and control machines, devices, apparatus, fixtures, and the like with better and less data required, resulting in better, more compact information as an input into control.

### BRIEF SUMMARY OF THE INVENTION

In view of the foregoing, in accordance with the invention as embodied and broadly described herein, a method or process is disclosed along with a supporting apparatus and system collecting, mining, analogizing, and adapting data; processing, consolidating, and interpreting data to providing more and reliable information including predictions, projections, modeled outcomes, recommendations, and control parameters; and providing outputs as controls for execution by equipment in accordance therewith.

In one embodiment, data is maintained in a relational database, in which tables share a key field firmly based in physical reality, namely geographic location. By relating all records to geography, great disparities are spanned more easily, thus relating otherwise seemingly unrelated technologies and assets to each other. This simplifies data storage and retrieval, record sizes, and speed of access.

In addition, processing of information available periodically or sporadically from various assets identified in a database, can provide real-time control otherwise unavailable. This may include predictions on systems with no direct data, expansion and modeling of systems with limited data, and control over equipment, subsystems, and assets. This is of great benefit for equipment otherwise impossible to deploy accurately or timely based on deterministic analysis by conventional methods and systems.

Machines may be regularly accessed, inspected, torn down maintained, repaired, rebuilt, replaced, or otherwise serviced. Inspection is possible by meters, measurements, sensors, cameras, and so forth. Meanwhile, teardowns and open inspections are always an option, with some degree of effort, which is typically reasonable.

Reliability (typically measured by mean time between break downs), the availability (typically the total fraction of time that a machine is available for operation), the maintainability (typically measured in terms of service hours required per hour of operation, and sometimes by fraction of downtime required for maintenance), and durability (typically measured in lifetime or number of operations or number of output production quanta) may be documented.

Meanwhile, the cost, frequency, interference, and the like associated with maintenance, repair, failures, and the like may be tracked. Accordingly, financial decisions and capital investment decisions may be made.

Computerized systems for data acquisition, information processing, asset condition analysis, life and serviceability rating decisions, service recommendations, and communications are disclosed in certain embodiments of systems in accordance with the present invention as including a system server maintaining a database of information and predictive analyses including a maintenance score, a maintenance scoring system, and an integrated scoring system incorporating maintenance scoring and condition scoring of infrastructure assets.

In certain embodiments, an infrastructure system, such as the infrastructure of a city may be managed through a work station associated with an employee, agent, agency, responsible individual, or other management organization. Meanwhile, an oversight organization or oversight supervisor may also use information and predictions in order to assist in making decisions. Decisions may involve capital investment, maintenance investment, and analysis of tradeoffs between capital investment and maintenance investment.

In one embodiment of an apparatus and method in accordance with the invention, information from inspection records, as-built records, expenses, assets and attributes of infrastructure elements and systems, work orders and historical accumulations of work done on work orders and the expense thereof and time, money, and so forth, may all be incorporated into a database of records by a work station, or collected by a work station and forwarded to a system computer. Execution of functions and software may be on standalone computers, networked computers, or over an internetwork between computers. In one embodiment, a geographical information system database (GIS) available from Environmental Systems Research Institute (ESRI) may be used to link information and presentations to geographical positioning of assets, in order to improve the understanding of an individual conducting a query, analysis, or even inputs of data into the system.

In certain embodiments, statistical modules may maintain statistics on attributes of assets. Attributes may include, for example, location, type, dimensions, area, a region or district of responsibility, soils, climate, topology (connections), topography (elevation and geography), geology, materials, dates, ages, manufacturers, event history, workers who have accessed an asset, assessments by those who have worked on or accessed infrastructure elements, records, links, loads, flows, chemistry of contents or surrounding environments, traffic, times, seasons, identifiers, capacities, use cycles or duty cycles, vendors, installers, condition from inspections and reports, costs, condition scores, maintenance scores, integrated scores, and so forth.

Meanwhile, assets may include lines, pipes, fittings, fixtures, controls, connections, cables, poles, equipment, roads, canals, drainages, accesses, crossings, streets, trees, plants, buildings, ports, pumps, facilities, walks, signs, and any other asset that a city or industrial organization may choose to purchase, maintain, track, or the like.

In one embodiment of an apparatus and method in accordance with the invention, those responsible for an asset or various systems of assets may involve those with management responsibility, operations, field work, and others whether engineering, information technology, staff support, outside services support, and the like. Meanwhile, those with oversight, such as governmental oversight may also access a system and method in order to assess various information, scoring information, condition information, and real-life availability and lifetime expectations projected. A database in accordance with the invention may access a GIS database, as well as a record database, as well as various analyses that may also be conducted based on data stored, and which analyses may provide outputs, graphs, charts, projections, predictions, recommendations, and the like which may also be saved as records for future reference in order to document decisions, alter decisions, and rethink decisions.

Systems and methods in accordance with the invention stand in contrast to prior art systems of the blind following the blind, adopting a manufacturer's arbitrary, and often unjustified or unjustifiable, lifetime curve of deterioration or simple depreciation. With maintenance, deterioration may be slowed, repaired, reversed, or the like. Thus, straight line curves or any other curve needed may be calculated to necessarily reflect reality.

Moreover, a system in accordance with the invention may evaluate condition not as a simple function, but change of condition as a first derivative (mathematically speaking) of the condition, maintenance upgrades as an alteration or step change to improve or raise a condition, and otherwise changes the rate of change of condition, or even the second derivative or the rate of change of the rate of change of condition. Statistical analysis modules as well as numerical methods systems may assist in tracking, correlating, analyzing, predicting, and otherwise modeling system life, system costs, and trade offs between life, usefulness, maintenance, condition, and expenses related thereto.

In certain embodiments, a system and method in accordance with the invention may rely on similarly situated infrastructure assets within the same infrastructure system, within other remote infrastructure systems reported, or both in order to develop actual lifetime projections, predictions, and recommendations.

In particular, city infrastructure may include numerous assets, including pipes, other lines, whether cables, telephone, power, sewage, storm runoff, or the like, and so forth. These are often not available for ready inspection. All types of lines, whether appearing to carry data, power, water, sewage, storm runoff, vehicles, pedestrian traffic, or the like may have fittings, junctions, connections, spans, upstream events and components, downstream events and components, and so forth. Fixtures, controls, connections, and the like may all be present.

Meanwhile, cables, wires, poles, equipment, connection boxes, control boxes, and so forth may exist in various types of systems. Whether considering equipment, roads, canals, drainages, accesses, crossings, streets, trees, plants (biological or works plants), buildings, ports, whether airports, water ports, or otherwise, and so forth may all exist as infrastructure assets. Signs, walkways, pumps, other facilities, and so forth populate cities, as well as large industrial complexes.

At present, each individual one of such assets has an operational lifetime. That lifetime is virtually never actually known in conventional prior art systems. It may be assumed, warranted, or admittedly unknown, but it is not known. Thus, a city administrator may rely on systems and method in accordance with the invention to calculate, estimate, predict, compare, and recommend operations, conditions, and remaining life previously unknown, not waiting until an actual failure occurs.

Operational lifetime is typically specified in a specification included with a request for bids. Accordingly, manufactures, builders, installers, and so forth bid to install a particular infrastructure asset for a particular price. A manufacturer or installer may provide a depreciation curve, but it is not an actual life curve. That life curve is effectively a curve or line that plots available useful life on a ‘y’ or vertical axis and the passage of time in use on a horizontal axis. Like a depreciation curve, the asset is assumed to degrade over time. Once an asset has reached a useful life (as so specified) or utility less than about twenty percent, an asset is subject to review for replacement, but that is not a true test of its life.

Thus, in the invention infrastructure inspected for its condition informs computer modeling of lifetime, maintenance, repair, and inspection. An experienced expert may be relied on in a computerized expert system. Workers' visual inspections during certain tests, inspections, repairs, maintenance or other service serves to support modeling of an infrastructure asset. Similarly situated assets that have been opened up for inspection, such as a line that has been dug up may be used as analogs for data on unopened, uninspected systems. Accordingly, a system and method in accordance with the invention may estimate the life status or the remaining useful life that appears to be present at a particular location in a particular asset.

As a matter of history, the ground conditions and the workmanship of an installing company may far outweigh the influence of hardware component quality and the projected life assessed by manufacturers thereof. Based on a suspect prediction, expensive and spotty inspections, or a catastrophic failure, assets may be repaired, completely rebuilt, replaced, or otherwise put back into operational condition. This need not be, and certainly not at the virtually always too high cost in money and inconvenience. A system and method in accordance with the invention may provide detailed justification for life calculations, predictions of conditions, and recommendations for service, as well as ready calculations comparing conditions to expectations.

### BRIEF DESCRIPTION OF THE DRAWINGS

The foregoing features of the present invention will become more fully apparent from the following description and appended claims, taken in conjunction with the accompanying drawings. Understanding that these drawings depict only typical embodiments of the invention and are, therefore, not to be considered limiting of its scope, the invention will be described with additional specificity and detail through use of the accompanying drawings in which:

FIG. 1 is a schematic block diagram of a computer network, including several nodes or computers, one in detail, connected to a network, a server, and through a router to an internetwork suitable for implementing an apparatus and method in accordance with the invention and hosting software modules in accordance therewith;

FIG. 2 is a schematic block diagram of a system in accordance with the invention including hardware, software, and records for implementing an apparatus and method in accordance with the invention;

FIG. 3 is a schematic diagram of a network architecture for a system of computers implementing one embodiment of a system in accordance with the invention;

FIG. 4 is a schematic diagram of a map or topology of a system of infrastructure assets suitable for management by a system and method in accordance with the invention;

FIG. 5 is a schematic diagram of computer readable memory storing records of assets and their attributes, including a listing of typical assets and a selection of typical attributes corresponding to various assets;

FIG. 6 is a schematic block diagram of a computer readable, non-transitory memory storing certain executable modules for loading into a processor for executing a system and method in accordance with the invention;

FIG. 7 is a schematic block diagram illustrating various interactions between hardware information, executables, and records, in order to implement a system and method in accordance with the invention;

FIG. 8 is a chart illustrating a maintenance score curve and sample events or activities with scoring in order to create such a chart;

FIG. 9 is a chart of a condition score with various historical sample scores taken, based on inspections made on an infrastructure asset; and

FIG. 10 is an integrated chart illustrating a visual representation of condition and maintenance scores for direct correlation and presentation to a user.

FIG. 11 is a schematic block diagram of a method of repair of infrastructure components, systems, networks, other assets in accordance with the invention; and

FIG. 12 is a schematic block diagram of the processes of analysis, prediction, and comparison central to the NCF (Normalized Comparison Ratio) system and methods in accordance with the invention.

### DETAILED DESCRIPTION OF THE PREFERRED EMBODIMENTS

It will be readily understood that the components of the present invention, as generally described and illustrated in the drawings herein, could be arranged and designed in a wide variety of different configurations. Thus, the following more detailed description of the embodiments of the system and method of the present invention, as represented in the drawings, is not intended to limit the scope of the invention, as claimed, but is merely representative of various embodiments of the invention. The illustrated embodiments of the invention will be best understood by reference to the drawings, wherein like parts are designated by like numerals throughout.

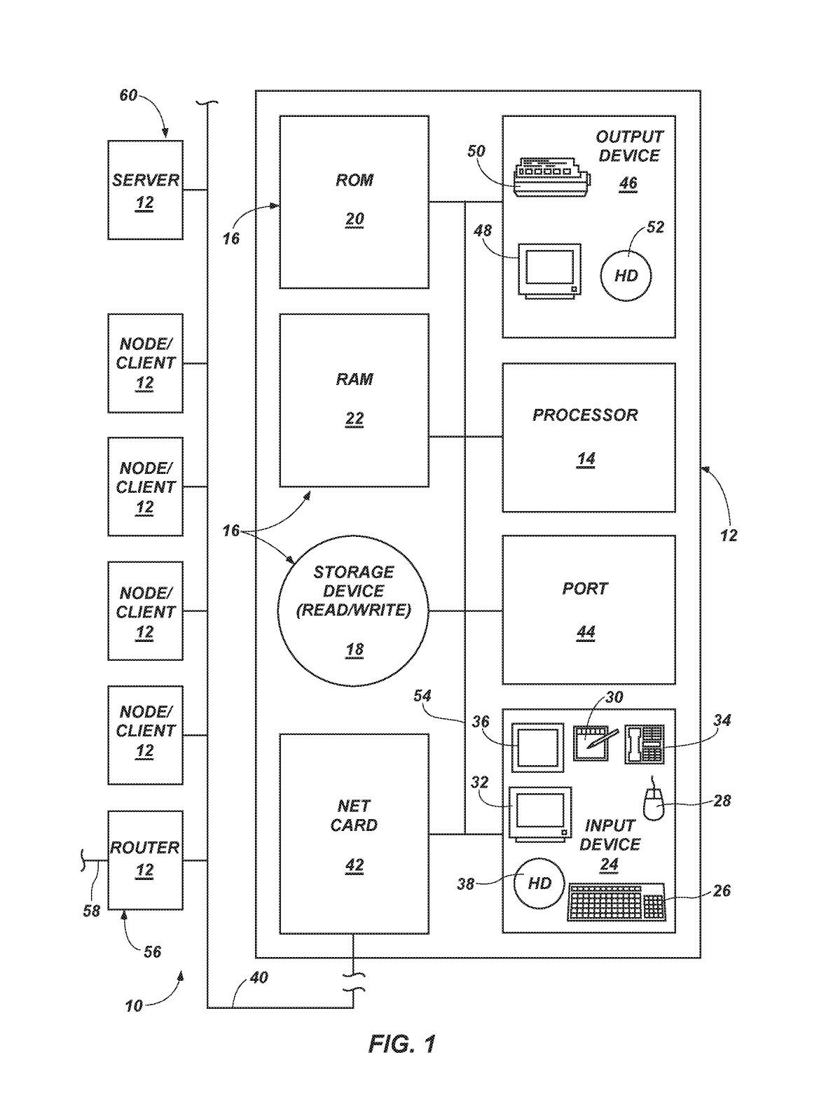

Referring to FIG. 1, an apparatus 10 or system 10 for implementing the present invention may include one or more nodes 12 (e.g., client 12, computer 12). Such nodes 12 may contain a processor 14 or CPU 14. The CPU 14 may be operably connected to a memory device 16. A memory device 16 may include one or more devices such as a hard drive 18 or other non-volatile storage device 18, a read-only memory 20 (ROM 20), and a random access (and usually volatile) memory 22 (RAM 22 or operational memory 22). Such components 14, 16, 18, 20, 22 may exist in a single node 12 or may exist in multiple nodes 12 remote from one another.

In selected embodiments, the apparatus 10 may include an input device 24 for receiving inputs from a user or from another device. Input devices 24 may include one or more physical embodiments. For example, a keyboard 26 may be used for interaction with the user, as may a mouse 28 or stylus pad 30. A touch screen 32, a telephone 34, or simply a telecommunications line 34, may be used for communication with other devices, with a user, or the like. Similarly, a scanner 36 may be used to receive graphical inputs, which may or may not be translated to other formats. A hard drive 38 or other memory device 38 may be used as an input device whether resident within the particular node 12 or some other node 12 connected by a network 40. In selected embodiments, a network card 42 (interface card) or port 44 may be provided within a node 12 to facilitate communication through such a network 40.

In certain embodiments, an output device 46 may be provided within a node 12, or accessible within the apparatus 10. Output devices 46 may include one or more physical hardware units. For example, in general, a port 44 may be used to accept inputs into and send outputs from the node 12. Nevertheless, a monitor 48 may provide outputs to a user for feedback during a process, or for assisting two-way communication between the processor 14 and a user. A printer 50, a hard drive 52, or other device may be used for outputting information as output devices 46.

Internally, a bus 54, or plurality of buses 54, may operably interconnect the processor 14, memory devices 16, input devices 24, output devices 46, network card 42, and port 44. The bus 54 may be thought of as a data carrier. As such, the bus 54 may be embodied in numerous configurations. Wire, fiber optic line, wireless electromagnetic communications by visible light, infrared, and radio frequencies may likewise be implemented as appropriate for the bus 54 and the network 40.

In general, a network 40 to which a node 12 connects may, in turn, be connected through a router 56 to another network 58. In general, nodes 12 may be on the same network 40, adjoining networks (i.e., network 40 and neighboring network 58), or may be separated by multiple routers 56 and multiple networks as individual nodes 12 on an internetwork. The individual nodes 12 may have various communication capabilities. In certain embodiments, a minimum of logical capability may be available in any node 12. For example, each node 12 may contain a processor 14 with more or less of the other components described hereinabove.

A network 40 may include one or more servers 60. Servers 60 may be used to manage, store, communicate, transfer, access, update, and the like, any practical number of files, databases, or the like for other nodes 12 on a network 40. Typically, a server 60 may be accessed by all nodes 12 on a network 40. Nevertheless, other special functions, including communications, applications, directory services, and the like, may be implemented by an individual server 60 or multiple servers 60.

In general, a node 12 may need to communicate over a network 40 with a server 60, a router 56, or other nodes 12. Similarly, a node 12 may need to communicate over another neighboring network 58 in an internetwork connection with some remote node 12. Likewise, individual components may need to communicate data with one another. A communication link may exist, in general, between any pair of devices.

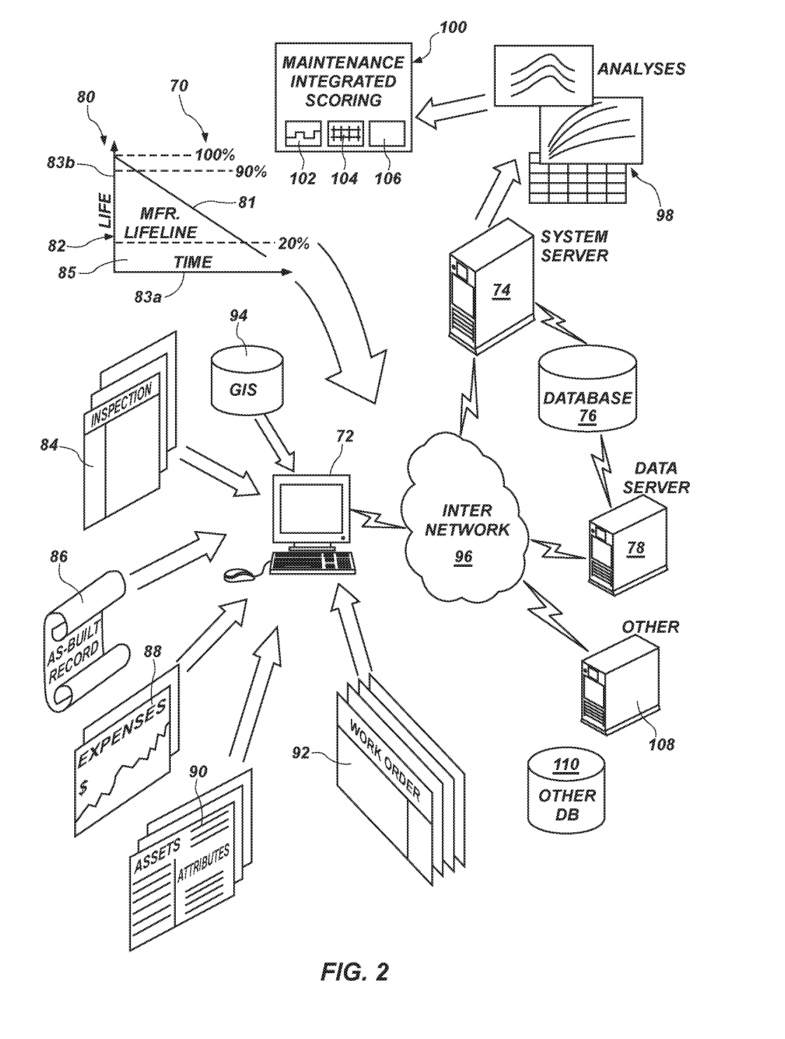

Referring to FIG. 2, a system 70 in accordance with the invention may rely on a station 72 or work station 72 operated by an employee, agent, responsible individual, responsible organization, or the like having responsibility with respect to certain aspects of infrastructure. Typically, infrastructure is associated with a city. Infrastructure may involve all those physical systems that make up the supporting systems of a city.

Similarly, industrial plants may likewise have infrastructure. However, in cities, particularly, much of the infrastructure is literally buried and not available for ready viewing, inspection, maintenance, or the like. Nevertheless, upon failure of certain systems, they may be excavated and inspected. Similarly, in some situations, systems may be shut down while cameras are run into lines to inspect those lines for condition.

The work station 72 may operate by a direct connection, or over an internetwork 96, to a system server 74. The system server 74 may access a database 76. In fact, the database 76 may be created and maintained by the system server 74. Nevertheless, the system server 74 may be connected to an internetwork 96 in order to provide information from the database 76 to users of that information, such as an operator of the work station 72.

A data server 78 or database server 78 may have responsibility for maintaining a database 76. In other embodiments, the data server 78 is simply responsible for performing certain functions to serve data from the database 76. For example, a database 76 may have a database engine that handles management of data inputs, reconciliations, verifications, as well as data outputs.

Typically, a query engine will be required in order to handle queries to the database 76. The data server 78 may have a query engine in a database engine programmed to operate therein. Similarly, the system server 74 may have a database engine. Typically, the database 76 will be controlled by only a single system or computer. Nevertheless, it is possible to have a synchronized database 76 accessed by multiple database engines, and reconciled in order to support such distributed access, input, and management.

In the illustrated embodiment, various information 80 may be provided through the work station 72. The information 80 may typically be uploaded to the database 76 by appropriate operation of the work station 72 in concert with the server 74 or the data server 78. Typically, the information 80 may include a chart 82 having axes 83a and 83b illustrating the passage of time on the axis 83a and the percentage of expected remaining useful life on the axis 83b.

In the illustrated embodiment, a curve 81 may be displayed in the domain 85 defined by the axes 83a, 83b. In the illustrated embodiment, the curve 81 is illustrated as a straight line. As a practical matter, the curve 81 may have a shape, but simple monotonic shapes are very typical. Straight lines are perhaps the most typical of manufacturers' and installers' life charts 82 provided with infrastructure assets installed.

Prior art systems rely substantially exclusively on the charts 82. Periodic inspections may result in the curve 81 being reset (elevated or depressed with respect to the vertical axis 83b according to an assessment of where in the remaining lifetime of an asset a particular asset has been revealed to be at a particular inspection). Meanwhile, a lifetime will typically be measured as a percentage of useful life.

Accordingly, at a time 83a of zero, installation has just been completed and the expected life or usefulness is one hundred percent or has a value of one hundred percent. In contrast, when the entire life has run out, the expected life is zero. However, at about or below twenty percent of expected life, maintenance typically becomes more expensive than capital expenditures, and an asset may be reviewed for replacement or upgrading.

However, as a practical matter, prior art practice has been to shift the curve 81 upward or downward, to reflect the actual, observed date or time on the axis 83a and the expected life value at that inspection on the axis 83b as represented by the curve 81. However, such a shift belies the reality. The fact that the particular asset has not operated along the curve 81 may be evidence that the slope of the curve, intervening maintenance, or other factors require consideration or could benefit the accurate determination of remaining life. Such factors should be incorporated into a better, real-life assessment.

Other information 80 may include, for example, inspections 84 or inspection records 84. As-built records 86 may include blueprints and other information that reflect the facts, materials, locations, configurations, conditions, and so forth of an asset and its surrounding environment at the time at installation. Similarly, expense records 88 or expenses 88 reflect expenditures both capital and maintenance. Expense records 88 may be maintained along with certain analyses of use between assets, years, or other parameters associated with an asset.

Meanwhile, asset records 90 may be combined in various forms or formats in order to identify particular assets and their attributes. Work orders 92 or work records 92 reflect a history 92 of work. However, all the information 80 may be thought of as history. Inspection reports 84 indicate what has been inspected, when, and typically will identify a condition of various assets according to certain parameters.

For example, a concrete pipe may have clogging, fracturing, pitting, or the like. Meanwhile, it may have a certain flow rate, may be sized to a certain capacity, might be documented as to its location, or the like. Meanwhile, as-built records 86, expenses 88, whether capital, maintenance, inspection, or otherwise, and other asset records 90 may all be useful as the total, agglomerated, historical record of an asset or system.

A geographical information system database (GIS database) may be available online database, or may be a dedicated database. A GIS database 94 may be available commercially and used by an operator of the work station 72. Moreover, the database 94 may be a partially extracted database 94 available from a larger database. In yet another embodiment, the database 94 may be a particular instance of a commercially available database, including not only geographical information but the local information regarding infrastructure locations linked to geographical information, in order to identify the locations, directions, dimensions, depth, and so forth, or other attributes and identifiers associated with various infrastructure assets.

In the illustrated embodiment, the internetwork 96 may connect the work station 72, the system server 74, and the like to one another or other computers 108 and other databases 110. Typically, other computers 108 may be other serves 108 that are responsible to provide data. For example, various websites are served by servers 108 providing information regarding products, services, organizations, and the like.

Meanwhile, numerous repositories of data may be accessible on other computers 108. In fact, online databases 110 may provide legacy information regarding any number of facts, systems, events, locations, and so forth. Thus, in certain embodiments, the work station 72, the system server 74, the data server 78, or the like may access and mine other computers 108, such as informational servers 108, as well as databases 110 or other sources of information. This may be a valuable source of information for similarly situated systems.

For example, a manufacturer, installer, or owner of other infrastructure may include similar materials, similar climate, or other attributes of similar infrastructure assets, or the like, or have data or reports regarding them. The system 70 may use that information in order to improve lifetime estimates or life projections. Meanwhile, such information may be used to perform statistical analyses or other analyses 98 on data.

For example, a work station 72 may be a dedicated work station or a captive work station owned by or responsible to a particular owner (e.g., city, industry, etc.) of infrastructure. Accordingly, that work station 72 will collect and work with the information 80 in the various records 82, 84, 86, 88, 90, 92, 94. However, a single system may be comparatively new and have no substantial history. Likewise, infrastructure, by its very nature, is not intended to see frequent service.

For example, water pipes are installed for decades, centuries, or longer. Power systems similarly have long lives. The information 80 available on a new system may be quite limited. However, other systems 108, 110 may have data available to assist in statistical, numerical methods, correlations, projections, modeling, and so forth.

If nothing else, other systems 108, 110 may simply provide additional data points for consideration. To the extent that the attributes of an asset can be identified in a system 70, similar attributes and information from similarly situated assets identified in other systems 108, 110 may likewise be used.

In the illustrated embodiment, analyses 98 may be performed by various analysis engines programmed for the task. Accordingly, integrated scoring records 100 or integrated scores 100 may be provided that reflect not only the actual status of particular infrastructure assets, but an integration of maintenance scores with condition scores, even augmented by life prediction scores. Life prediction scores may be actual, based on integrating condition scores and maintenance scores. They may include also projections of the effect of maintenance, and condition on the actual projected life of an asset.

For example, a real-life chart 191 may be included as part of the integrated scoring 100. Similarly, a user interface presentation 104 may provide opportunities for a user to graphically aggregate information and present it according to selection by attributes held in common, evidence comparatively similar, or the like.

Other presentations 106 may provide an ability to submit queries, an ability to conduct analyses, and even an ability to input hypothetical, “what if” types of questions into analyses in order to investigate options. Ultimately, the maintenance integrated scoring 100 assists in weighing options between upgrading, replacing, and ignoring infrastructure assets.

However, in a most simplified embodiment, simply providing a real-life chart 191 or curve 102 of actual life that incorporates maintenance scoring is valuable. A projection for the improvement in the life of an infrastructure asset is extremely valuable, and unavailable in prior art methods.

Most prior art methods are largely subjective, limited to inspections, vendor life curves, and manual access. These preclude an effective assessment of rates of change (mathematical first derivative) of condition, rates of change of those rates of change (mathematical second derivative), and so forth. Moreover, projections are not available. Rather, an individual human being may review a condition, at the time of a repair or with the cost of a scheduled (and typically expensive inspection), and thereby estimate an expected remaining life percentage.

Data available conventionally have been so sparse that such assessments are of only marginal value, and are not universal across an infrastructure system. For example, no city was built in a day. No city infrastructure assets of any type were typically installed all in a day. Accordingly, infrastructure systems will not deteriorate in a single day, or be deteriorated on a single day.

For example, snow and temperature (climate) conditions may change throughout a city. Climate conditions change over elevation, and with respect to geological features, such as bodies of water, geologic formations, and the like.

Climate may dramatically influence certain conditions. Frost heaving is ubiquitous in environments that have deep freezing in the wintertime, and substantial water. Thus, comparatively northern climates having comparatively large annual rainfall quantities or values may be more susceptible to frost damage to infrastructure elements such as pipes, roads, streets, and so forth. Similarly, installers vary from system to system, from project to project, and from week to week.

For example, a particular project may be installed by one installer, and a second phase or a continuing phase may be installed by a separate installer years or decades later. The skills, practices, and other attributes of a particular installer may overwhelm other factors. Similarly, geology may overwhelm other factors.

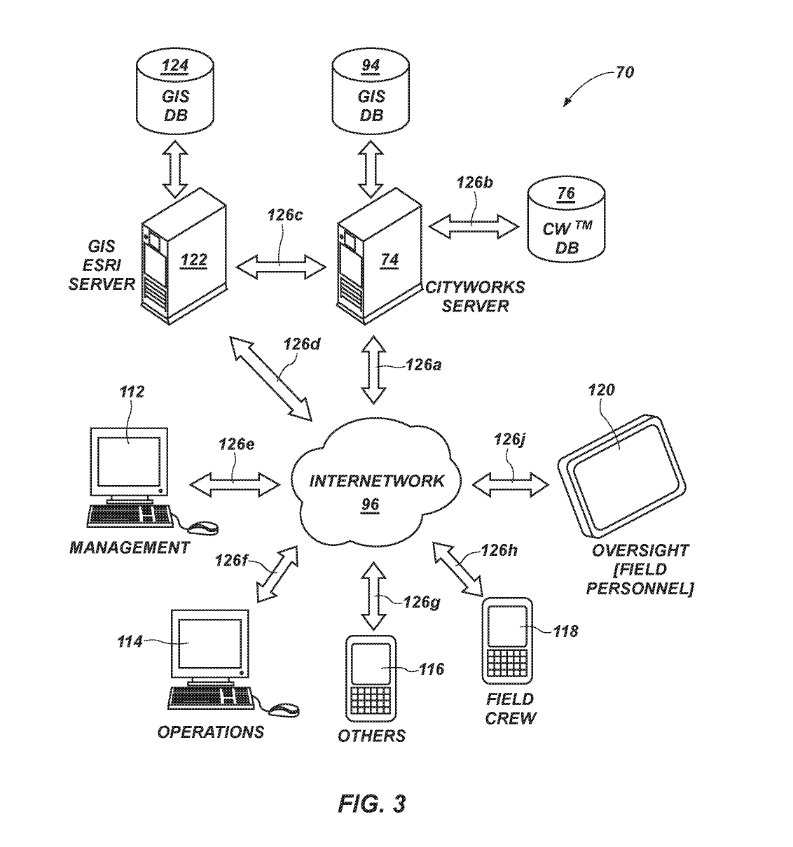

Referring to FIG. 3, in one embodiment of a system 70, various hardware assets 132 or apparatus assets 132 may be involved. For example, in the illustrated embodiment, a work station 72 may be embodied in any management computer 112 serving individuals in a management capacity over an infrastructure system. Meanwhile, an operations computer 114 may serve those who work in operations. Typically, management 112 may be thought of as city managers, departments' managers, and so forth. Meanwhile, an operations computer 114 may serve the day to day operations of particular individuals and organizations responsible to actually purchase, maintain, service, repair, and otherwise work on infrastructure assets.

Similarly, others, such as engineering departments, information technology departments, GIS support organizations, and other administrative staff and operational staff may rely upon other computers 116 or other computing devices 116.

Field organizations may rely on field computers 118. For example, crews onsite may rely on mobile computers 118 in order to obtain data, conduct tests or checks, or report in on particular activities of installation, maintenance, repair, inspection, or the like.

An oversight computer 120 may be thought of as a computer 120 operated by or on behalf of those having oversight over a system of infrastructure. For example, those with responsibility to make decisions on purchase, maintenance, service, and the like may be thought of as those having oversight 120. In many embodiments, an oversight computer 120 may actually be under the use and control of a governmental agency having oversight over those who may manage through a management computer 112 an infrastructure system.

In the illustrated embodiment, the various computers 112 through 120 may operate directly with one another, over a network, or over an internetwork 96, such as the internet, for example.

Meanwhile, a server 74 accessing a GIS database 94 may maintain a City Works™ database 76 for use by the computers 112 through 120. Typically, the database 76 may be dedicated to a particular infrastructure. In certain embodiments, the server 74 may actually be either dedicated to a particular infrastructure system, such as that owned by a single city, or may be an online server 74 available over internetworks 96, and hosting databases 76 of various, different, independent infrastructure systems.

Typically, although a GIS database 94 may be accessible, and even resident in a server 74, an ESRI server 122 may maintain a generic or generalized GIS database 94 124. Typically, the GIS database 94 is an extract, and may include additional information related to the various assets. Thus, the GIS database 94 may actually permit any particular user to access geographical information integrated with infrastructure information, in accordance with the invention, in order to integrate geography, space, assets, attributes and the like, in a single representation presented to a user.

Various communications 126 exist between the elements of the system 70. In the illustrated embodiment, and throughout this specification, a trailing reference letter indicates a specific instance of the base reference numeral. Accordingly, the communication 126a between the server 74 and an internetwork 96 is simply a specific instance of communications 126. Accordingly, the communications 126b, 126c, 126d, 126e, 126f, 126g, 126h, 126j are specific instances of communication used by the various devices in communicating with one another to upload, download, and otherwise access information, such as the information 80.

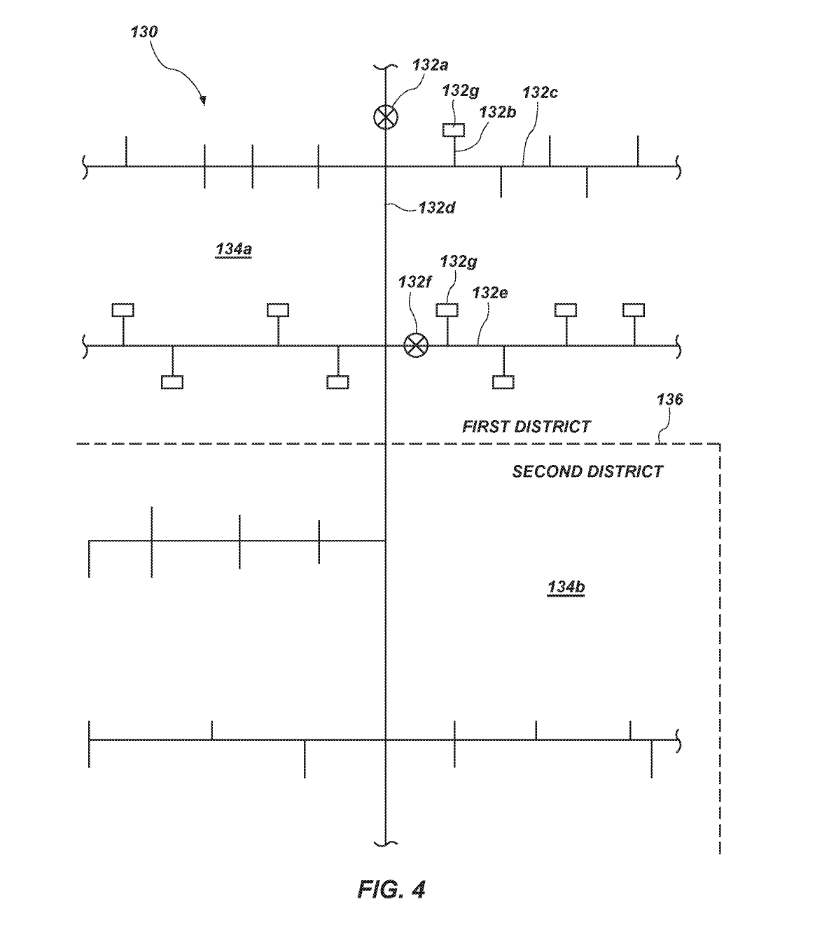

Referring to FIG. 4, a map 130 or chart 130 represents a topology 130. In certain embodiments, the topology 130 may actually be viewed as schematic representations of various infrastructure assets overlaid on an actual map. That map may be provided in any amount of graphic detail, accuracy, reality, scaling, or the like. In certain embodiments, the topology 130 may integrate information from the GIS database 94 along with asset information or attributes from the database 76.

In the illustrated embodiment, various assets 132 are shown. These assets 132 may be, for example, valves, control boxes, various junctions, junctures, or the like. Meanwhile, such assets 132 may include various lines 132b, 132c, 132d. Those lines 132 may represent any type of an interconnection between other assets. For example, the asset 132a may be a valve controlling water. The water may be distributed through various lines 132b, 132c, 132d. For example, a main 132d may deliver water to a spur line 132c, which also delivers water to a specific delivery location line 132b. Meanwhile, other terminal units 132g may exist at the terminus of a particular delivery line 132b. Various lines 132e and controls 132f may exist within the infrastructure topology 130.

Meanwhile, the area, where the divide may be shown schematically according to responsibility, or physically according to region or area, may be identified by some particular parameter or indicator. For example, in the illustrated embodiment, the topology 130 is divided between districts 134a, 134b. A boundary 136 establishes the limits of the adjacent districts 134.

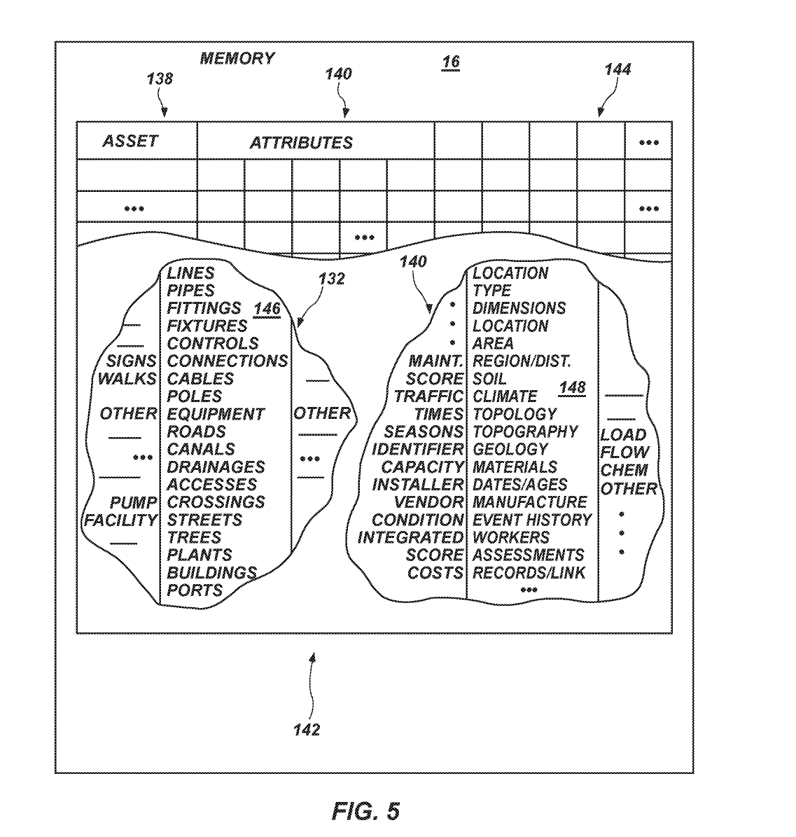

Referring to FIG. 5, various assets 132 may be characterized or identified by an identifier 138 or ID 138. Associated with each asset 132 may be various attributes 140. In the illustrated embodiment, a particular asset 132 may have associated therewith an ID 138 and a host of attributes 140 in an asset record 142. Asset records 142 may be individual records, or may simply be entries, lines, or rows within a particular table 144.

In the illustrated embodiment, a list of assets 132 or names 146 of assets is shown. They are schematically illustrated as the names 146 or the list 146 of names of assets 132 corresponding to the identification 138. Similarly, a list 148 of attributes 140 is illustrated schematically. They 140 appear in an underlying list 148 from which attributes 140 may be selected, or indicated.

In the illustrated embodiment, assets 132 include, for example, lines, pipes, fittings, fixtures, controls, connections, cables, poles, equipment, roads, canals, drainages, accesses, crossings, trees, streets, plants, buildings, ports, airports, water ports, ports of entry, signs, walks, pumps, facilities, and other possible assets 132. Meanwhile, some typical attributes 140 include such characteristics as location, type, dimensions, area, region, district, soil, climate, topology, topography, geology, materials, dates, ages, times, manufacturers', events, history, workers, assessments, records, links, traffic, seasons, identifiers, capacities, installers, vendors, conditions, integrated scores, costs, loads, flows, chemistry, maintenance scores, integrated scores, and other attributes 140 that may characterize a particular asset 132.

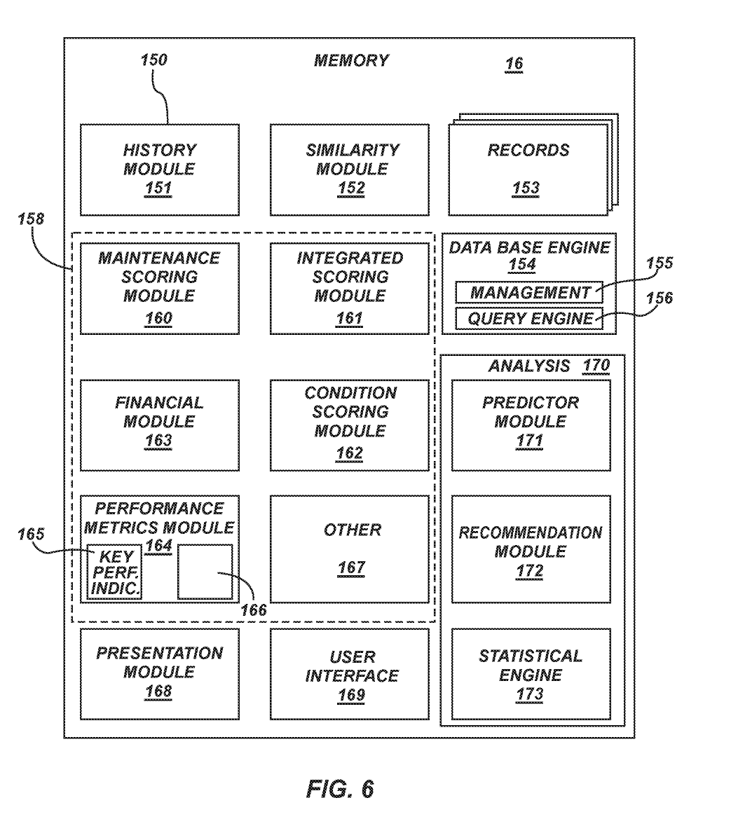

Referring to FIG. 6, in memory 16 associated with a particular computer 12 or computing device 12 in accordance with the invention, may be hosted a number of modules 150 for loading into a processor 14 for execution. In the illustrated embodiment, a history module 151 may be responsible for gathering, maintaining, and otherwise handling historical information. This may involve accessing, creating, downloading, or otherwise handling various records as having been discussed hereinabove.

Meanwhile, a similarity module 152 may be responsible for gathering historical information and linking information that relates similarly situated assets 132 and attributes 140 for use in combination with the historical data obtained by the historical module 151. Of course, a database 76 will maintain information, such as records 153. However, the history module 151 and the similarity module 152 may also be tasked with the job of mining, locating, perusing, parsing, and otherwise extracting data either from the records 153 of the database 76, or from other servers 108 or other databases 110 as described hereinabove.

In the illustrated embodiment, a database engine 154 may be responsible for managing a database 76. For example, a management module 155 may be responsible for the intake of records 153, and the proper storing, indexing, and other administrative functions of the database engine 154 in maintaining records 153. Meanwhile, a query engine 156 may be responsible for receiving queries and to output responses thereto from the records 153 for users of the database 76.

A scoring module 158 may be thought of as a set of other modules responsible for various evaluation or scoring activities.

For example, a maintenance scoring module 160 may be responsible for gathering and maintaining scoring for particular assets 132. Maintenance scoring modules 160 may be created for specific assets, or may be programmed into a single module 160 for handling any one of several assets 132. For example, a maintenance scoring module 160 may be responsible for providing templates and dialogue boxes in order for a user to input various events, activities, records, numbers, values, and the like that reflect activities that will eventually be managed in order to create maintenance scoring. Meanwhile, the maintenance scoring module 160 may be responsible to process the data in order to develop and maintain a current maintenance score for a particular asset 132, a system, or the like.

Similarly, a maintenance scoring module 161 may be responsible to integrate the results of a condition scoring module 162 and a maintenance scoring module 160. For example, a condition scoring module 162 may be responsible for receiving, inputting, outputting, processing, and otherwise obtaining and maintaining condition scores associated with a particular article 132 of infrastructure.

For example, to the degree of granularity that an infrastructure may identify specific assets 132, the maintenance scoring module 160 and condition scoring module 162 may be responsible for collecting information and using information, processing. This may include information regarding maintenance activities and condition inspections needed to provide an integrated score from the integrated scoring module 161.

In various embodiments, a maintenance scoring module 160 may operate alone. In other situations, a condition scoring module 162 may operate alone. On the other hand, an integrated scoring module 161 may rely on both maintenance and inspection information in order to provide an integrated score that reflects a prediction of remaining life (useful life, or utility) in a particular asset 132.

A financial module 163 may be responsible for collecting, analyzing, processing, and otherwise handling financial information. For example, whenever maintenance occurs or an inspection occurs, certain financial costs are involved. A capital expenditure, whether it be a new acquisition or an actual payment against a particular mortgage of an asset 132, will create a financial event. Accordingly, the financial module 163 is responsible for collecting, tracking, processing, and outputting information regarding financial information related to the acquisition, inspection, maintenance, repair, and so forth of a particular asset 132.

In certain embodiments, a performance metrics module 164 may be responsible for obtaining, processing, outputting, presenting, and otherwise managing performance metrics. For example, performance metrics 164 may be related directly to a condition or maintenance of an asset 132.

On the other hand, performance metrics 164 may relate to the teams, crews, organizations, departments, and the like responsible for particular assets 132 or collections thereof. For example, certain performance metrics 164 may include the average, maximum, minimum, or other time by which a service request is completed.

Likewise, certain types of work orders may be identified as to the date of their opening, their closing, and all days on which work was performed against the order. Meanwhile, costs of particular operations, such as maintaining lines, cleaning lines, re-lining pipes, and so forth may be identified. Also, performance metrics 164 may involve minimum, maximum, continuing, periodic, or net annual costs for a particular operation.

Meanwhile, labor costs, overtime costs, and the like may be performance metrics tracked by the performance metrics module 164 in order to give some clear indication of the effects of the condition, maintenance, and the like of an asset 132. Particularly, performance metrics 164 may be indicators that maintenance is required. By the same token, performance metrics 164 may also indicate the benefit to be realized by an upgrade. For example, maintenance or repair has affected the cost, life, or both of a particular asset 132.

Key performance indicators 165 maintained by the performance metrics module 164 may involve any or all of the parameters by which performance is measured. Typically, a lead time is a time between a request for work and a response, whether a contact response to the requester, the initiation of work, the completion of work, or the like. Any or all such time spans may be set as a performance parameter.

Even a goal or standard may be set as a key performance indicator 165 for any particular activity, cost, or other parameter. Such goals then may work into key performance parameters by way of whether or not a particular key performance parameter, when measured as reported, meets a minimum, maximum, average, or other quantifiable standard.

Other parameters 166 or outputs 166 may be obtained, processed, output, or managed by the performance metrics module 164. These may be selected by individuals responsible for oversight, management, operations, support, or field completion of tasks.

Other modules 167 may exist within the system 150 of modules, within the scoring module 158 or life module 158, or both.

A presentation module 168 may provide for graphical presentation to a user of information related to individual records 153, combinations of records 153, historical aggregations, comparisons with similarly situated systems or assets 132, and the like.

The presentation module 168 may be operated through a user interface 169 by which a user may select various information for presentation by the presentation module 168.

Typically, the presentation module 168 will be responsible to obtain information from other modules 150 in order to provide a graphical presentation. Thus, a presentation module 168 may actually do a certain analysis, but will typically be involved with analysis associated with graphical representations, aggregations, historical tracking, and the like.

In certain embodiments, a system of modules 150 may include an analysis module 170. Typically, a predictor module 171 may be of most value. The predictor module 171 may operate, for example, by using numerical methods solutions to complex equations, curve fits, and the like in order to predict more precisely the life expectancy or the remaining life utility of a particular asset 132 or combination thereof. In certain embodiments, a recommendation module 172 may actually use the predictor module 171, or the outputs thereof, or both in order to compare costs and render a recommendation.

An analysis module 170 may include several other modules 171, 172, 173. Typically, one basic module is a statistical engine 173. For example, various information may be of statistical significance from the various records 153 associated with various infrastructure assets 132. The frequency of repairs, the times and duration offline for repairs, the actual usable time, the duty time, time between failures, times during failures, repair time, the man hours required for repairs, the costs, and so forth may all give rise to statistics that may be analyzed by the statistical engine 173.

By analyzing statistics, the statistical engine 173 may correlate various assets 132 according to selected attributes 140. For example, correlations between assets 132 having similar attributes 140 may provide information regarding suitability of materials, installers, vendors, seasons, ages, regions, geographies, geologies, climates, and the like. They may inform oversight agencies and managers in making determinations as to expected life, expected costs, and so forth.

Similarly, a predictor module 171 may use numerical methods, curve fitting, and other sophisticated analysis to predict functions, remaining life percentage values, rates of change of condition, maintenance activities, or function, capacity, or other attributes 140 as they depend upon other facts, factors, or attributes 140. Typically, the predictor module 171 may prepare prediction equations that provide predictions of life, life increase, rate of life decay, rate of life improvement, and so forth.

For example, certain activities by way of repair, service, and the like may provide an increase in the expected life or the useful life of an asset 132. Every activity will not provide the same restoration of life. Thus, a predictor module 171 may provide predictor equations by way of numerical methods, curve fits or the like. Typically it 171 will identify the increase in life based on particular events or activities, such as repairs, replacements, refurbishments, and the like. Thus, the predictor module 171 greatly enhances the accuracy of predicted life or the expected life of a particular asset.

By the same token, a recommendation module 172 may go a step further and use the predictor module 171, or the outputs thereof, in order to compare financial costs from the financial module 163 with predicted life from the predictor module 171. Accordingly, one with oversight or management responsibility may then learn how much life may properly be added to the useful term of an asset 132 if certain activities are undertaken. Thus, the recommendation module 172 may be programmed for providing a sensitivity analysis of how much life per dollar may be provided by any particular service or rehabilitation activity in the maintenance of an asset 132.

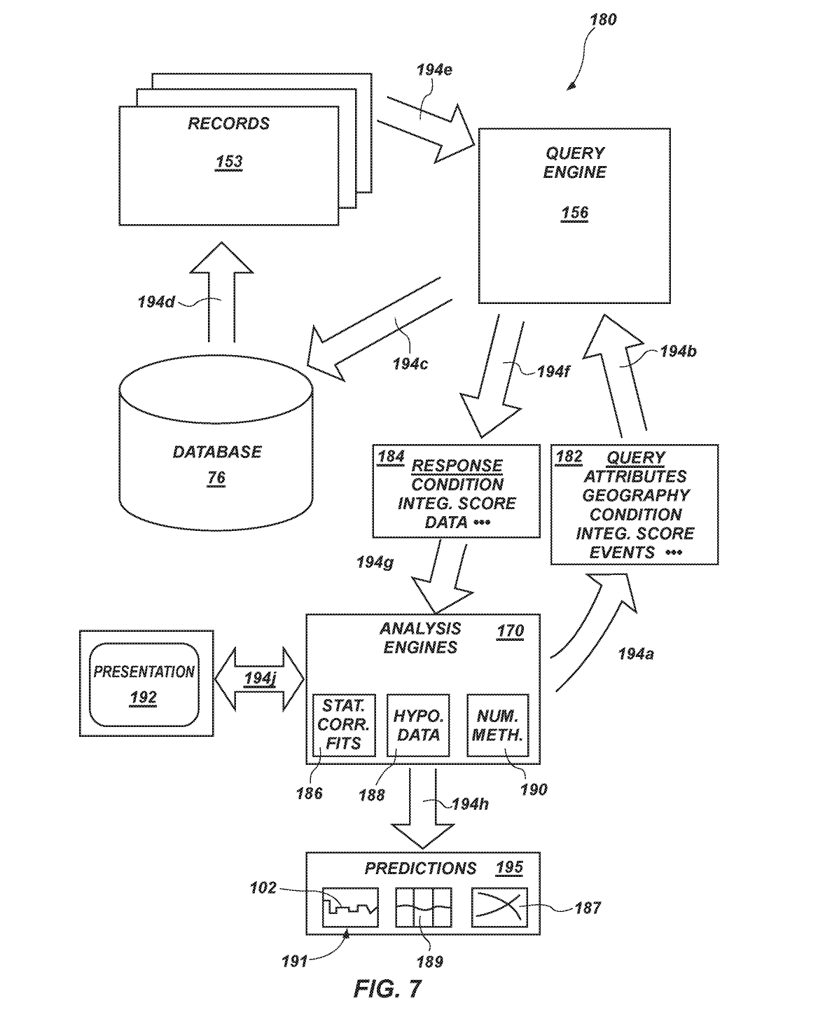

Referring to FIG. 7, a process 180 for implementing an apparatus and method in accordance with the invention may rely on the database 76 and records 153 in order to provide for viewing, considering, analyzing, comparing, and otherwise extracting information from data in order to provide information for decision makers. For example, in the illustrated embodiment, a particular analysis engine 170 or a module 171, 172, 173 therewithin may analyze information from a query to determine, select, and pass information based on a query 182 to a query engine 156. The query engine 156, may thus communicate 194c with a database 76.

The query engine 156, querying the database 76, may elicit a communication 194d providing records 153 back to the query engine 156 for formulation and delivery 194f of a response 184. The response may include a condition, data, charts, graphs, figures, and the like. In one embodiment, a maintenance score (e.g. adjustment of remaining percentage of life) may be returned.

In other embodiments, an integrated score integrating both maintenance scores and condition scores to provide an effective life may be returned. In certain embodiments, an analysis engine 170 may implement other modules 186, 188, 190 in order to accomplish its desired results. For example, a statistical module 186 may do correlations, curve fits, and so forth of historical, statistical, or other data.

Meanwhile, a hypothetical data module may provide for inputs of hypothetical conditions in order to test the expected or probable percentage change in life expectancy if certain hypothetical actions were taken.

Likewise, a numerical methods module 190 may implement functionality, such as that of a predictor module 171 discussed hereinabove. Accordingly, the analysis engine 170 eventually communicates 194h predictions 195. In the illustrated embodiment, a real-life chart 191 or curve 102 may be presented. In the illustrated embodiment, the chart 191 may include a life curve 102 much improved over that of a manufacturer or installer. For example, the chart 191 may present a real-life curve 102 that indicates the actual historical life, and a predicted life, based on integrating a maintenance score into the upgraded life profile 102.

Similarly, a chart 189 may provide an integrated score based on certain events occurring at certain times to alter the life. A comparison chart 187 may provide a juxtaposition of certain curves. For example, it may combine for comparison and display the cost of maintenance, cost of ownership, capital expenditure, or the like. Accordingly, trade offs may be determined by a comparison chart 187 that contains predictors of life, expense, maintenance costs, capitalization costs, technology improvements, or the like.

In one embodiment, a presentation 192 may be provided from the analysis engine 170 directly, or from storage 16, in response to inputs from a user, or the like. Communication 194j between the analysis engines 170 and the presentation 192 may permit interaction. A user, through a user interface 169 may obtain underlying support from the presentation module 168 in order to prepare the presentation 192, and provide the outputs to a user.

Typically, a presentation 192 will include spatial (e.g. geographic, regional), temporal (time-based), color, and other features in order to render the information presented more isolated, identifiable, aggregated, grouped, collected, reduced, or otherwise made more understandable. Meanwhile, the presentation 192 may include information extracted, filtered, and otherwise collected and presented. This may be done according to space, time, asset 132 type, attribute 140, or the like. Thus, one may search for particular assets 132 of a particular type that share certain attributes.

The presentation 192 may provide various charts comparing assets and attributes. It may thus provide great insight to an individual responsible for execution, inputs, decisions, management, oversight, or operation of a system 70 in accordance with the invention.

The communications 194a through 194j may operate to collect, fetch, output, read, write, process, or otherwise transfer data between modules, between hardware, between the individuals, between databases, or the like. Accordingly, a user may access any particular information or data, and have it presented as useful information informative for decisions.

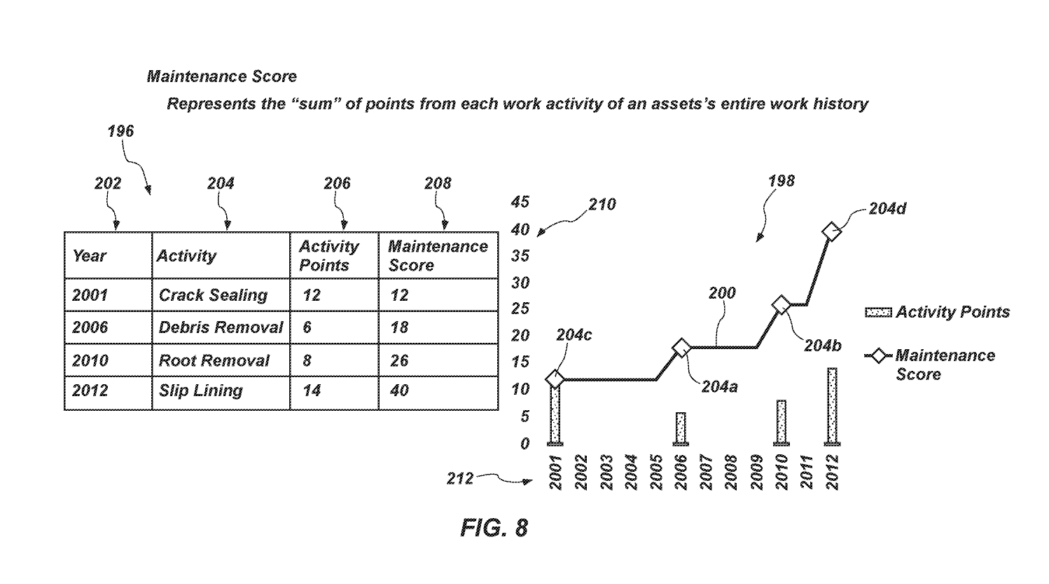

Referring to FIGS. 8 through 10, in certain embodiments, information may be obtained with minimal complexity, minimal mathematical manipulation, and so forth. For example, prior art methods and apparatus known to Applicant have no inclusion of maintenance as a separate life-extending factor. Maintenance represents a cost in any physical system. However, maintenance may be of several different types. A repair may simply return a non-functioning unit 132 or asset 132 into a functioning unit 132. It may not extend the life at all. Similarly, certain types of maintenance are simply required. Lubrication of machine parts, removal of debris, and so forth are routine maintenance that may not affect life, extend life, or the like, yet will maintain performance.

On the other hand, replacement of key components may extend life. Repair of key components may extend life. For example, water lines that have existed for decades or centuries in certain cities may be re-lined by modern techniques.

Such re-lining procedures may give a structure an entirely new life. For example, new polymeric tubes may be inserted into a conventional stone, concrete, or cast line, greatly improving the life. Meanwhile, cleaning, removing roots, and the like from drain lines may provide increased life, but may also be required periodically simply to maintain function.

Referring to FIG. 8, a table 196 is shown along with a graphical representation of a chart 198. In the illustrated embodiment, a score 200 (or a curve 200 providing a value 200 representing a score) of remaining percentage of life is illustrated. In the illustrated embodiment, a year 202 is represented and various events 204 (e.g., 204a, 204b, 204c, 204d) are identified. Associated with each event 204 or activity 204 is a value 206 called points 206. Points 206 are a result of analysis providing a life percentage improvement based on the results from the corresponding activity 204 or event 204. Here, the points 206 amount to a percentage of life extended by virtue of the respective activity 204 or event 204.

A cumulative score 208 represents the total number of points 206 accumulated. The accumulated or cumulative points 208 effectively should be subtracted from the degradation of an asset 132. Put another way, the points 208 represent percentage points by which the life of an asset 132 is extended by virtue of the combination of various activities 204 or events 204.

Illustrating the data from the table 196 in the chart 198, the life 210 or the value 210 along an axis 210 represents a percentage of life. Meanwhile, another axis 212 represents the years 202 from the table 196. In various locations, certain events 204a, 204b, 204c are illustrated schematically.

Associated with each event 204 is a particular resultant change or establishment of the value of the curve 200. Thus, the curve 200 represents the life 210 or percentage of life added by virtue of the particular activities 204 or events 204. Thus, in the illustrated embodiment, a value of remaining life originally was between ten and fifteen percent remaining. It was extended to about forty percent. Thus degradation was reversed and the life score 200 was extended.

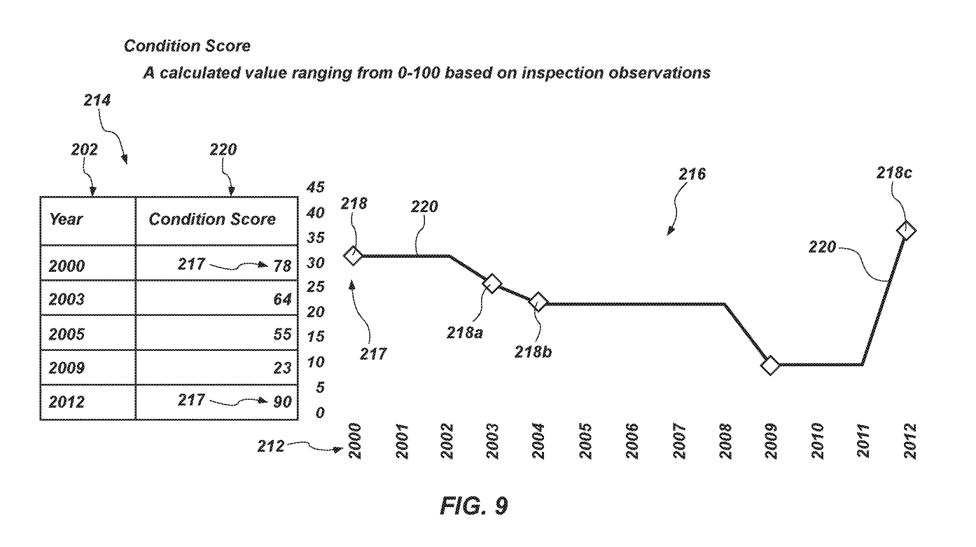

Referring to FIG. 9, a condition score is illustrated. A table 214 contains information relating the numerical values of the chart 216 therein. At any chart location or year 202, a value 217 is associated. One may think of each of the entries in the table 214 as representing an inspection. Thus, for any year 202 listed, a value 217 of a score 220 is listed. In the illustrated embodiment, various inspections 218 identify particular years 202 along the timeline 212 or axis 212. Accordingly, the condition score 220 alters between inspections 218 occurring at various dates 202.

In general, a condition score 220 simply reflects an assessment by a knowledgeable professional who has inspected a particular asset 132. A score 220 may have a certain amount of uncertainty and subjectivity. To the extent that information may be obtained quantitatively (such as by testing), the score 220 may be more reliable and objective.

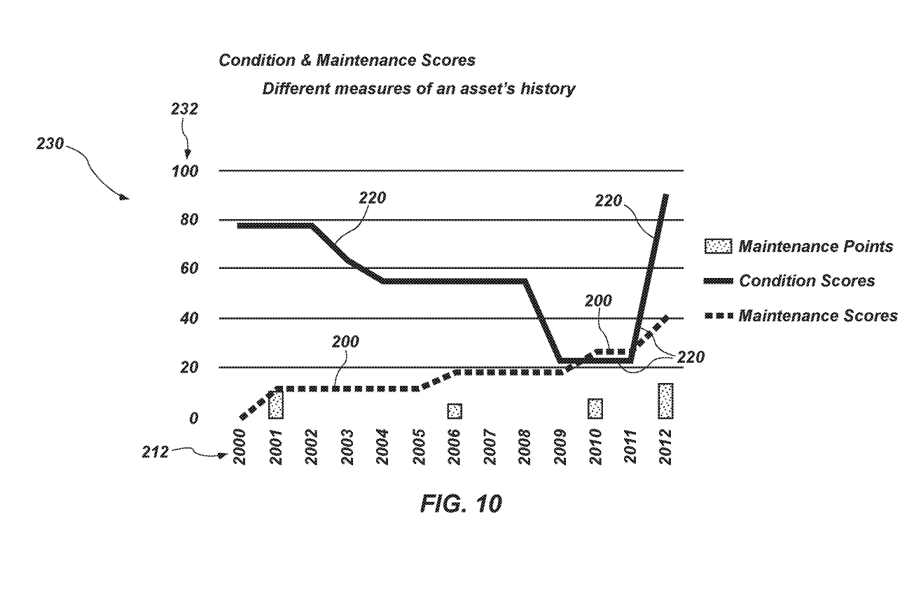

Referring to FIG. 10, an integrated or combined chart 230 illustrates an axis 232 representing remaining life. The life 232 or the life axis 232 represents a percentage of remaining useful life corresponding to a particular asset 132. In the illustrated embodiment, the curves 200, 220 of the charts 198, 216 are combined. Thus, each relies on the same timeline 212 or time axis 212. Similarly, each relies on the same life axis 232.

One may see how the maintenance score 200 integrated with the inspection score 220 results in a different value 217 for the condition score 220. Due to the knowledge imparted by the points 206 and the accumulated or cumulative points 208 additional life 232 is credited to an asset 132. An integrated chart 230 provides greater insight, and a more realistic, or real-life, curve 102 (see FIG. 7) for the life expectancy of the asset 132.

In many instances, the chart 220 may not even be available. That is, the curve 220 represents a condition that may or may not be available for inspection. However, maintenance scores 200 provide the ability to augment condition scores 220 in order to provide a more realistic condition score 220 or an integrated condition score 220. In certain embodiments, an integrated, maintenance, condition score 200 may provide a better detail on the expected life.

Meanwhile, the analysis engine 170 takes the chart 230 to a different level. Using the predictions 195 from the analysis engine 170, other information, such as that obtained from other databases 110, other servers 108, and the like may provide similarity data from the similarity module 152. For example, certain records 153 may actually represent documentation from the similarity module 152. Thus, modeling by the analysis engines 170 may provide additional data to the system 70 in situations where either condition scores 220, maintenance scores 200, or both are either absent, or sparse. Thus, interpolation, extrapolation, and modeling by the analysis engines 170 may provide more realistic life charts 230.

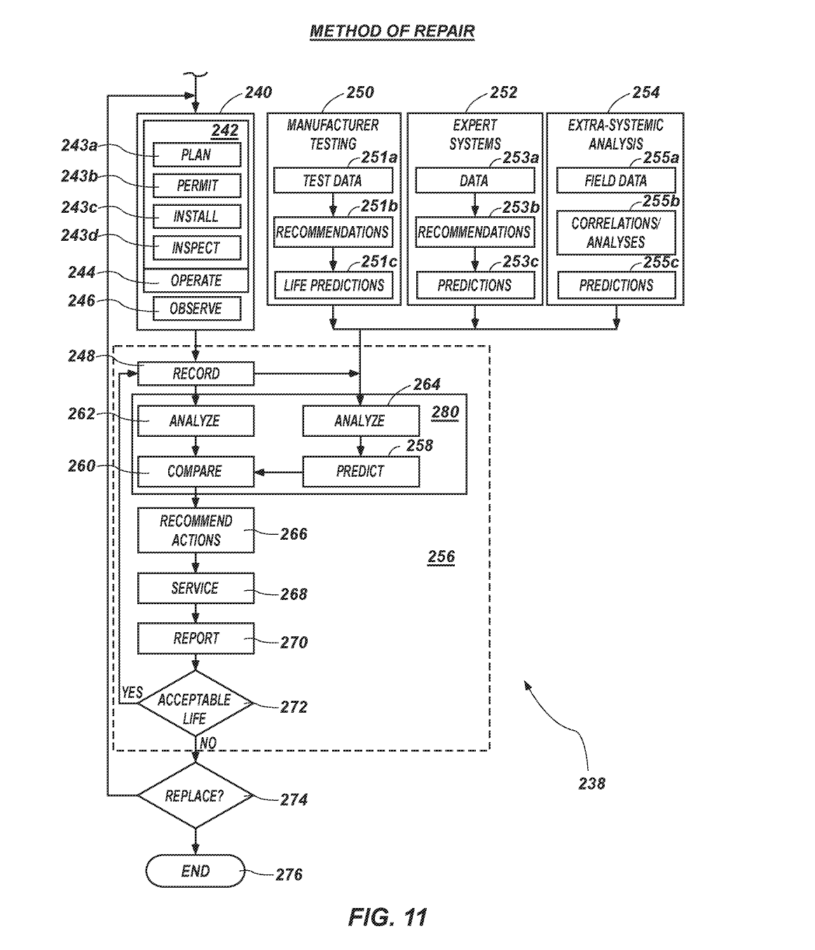

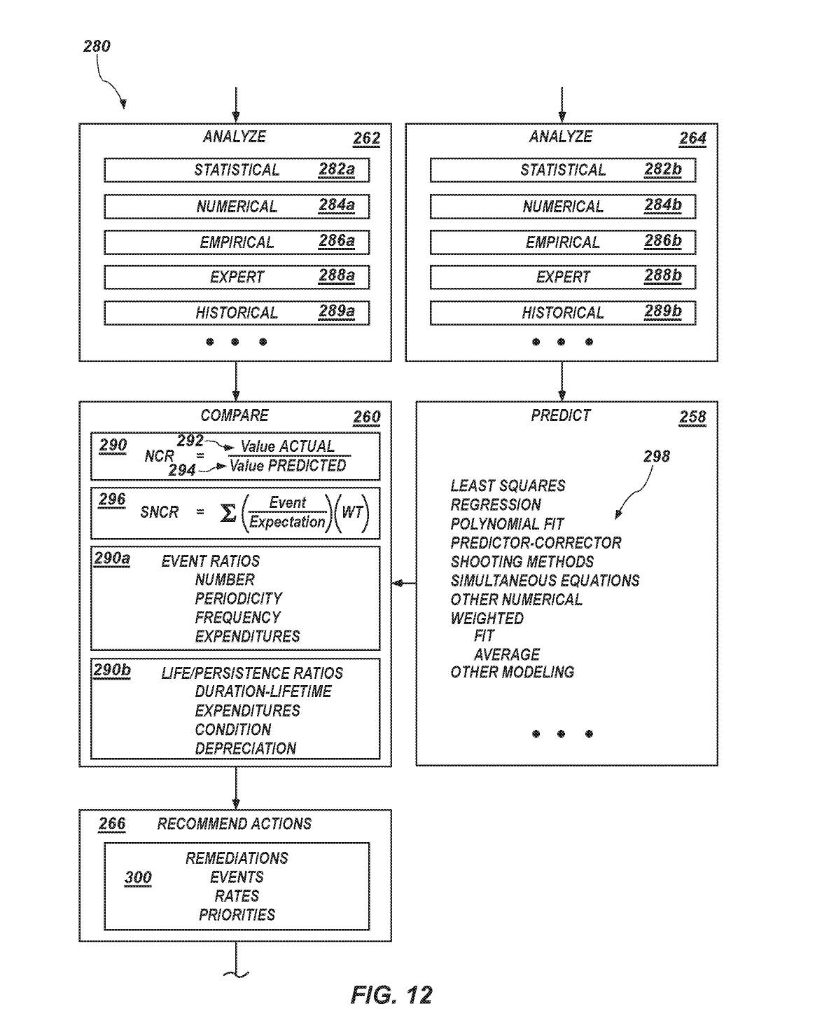

Referring to FIGS. 11 and 12, while continuing to refer generally to FIGS. 1 through 12, certain systems and methods are illustrated. Each item in each of the logical portion of (executable code) schematic block diagrams of FIGS. 11 and 12 may be thought of as a module responsible for collecting data, analyzing data, calculating information, conducting comparisons and decision making, and otherwise executing steps required in accordance with an apparatus and method in accordance with the invention.

By the same token, each block in the schematic block diagrams may be seen as well as a process step. Thus, each may be viewed as a process step, an action, or an executable module for conducting, supporting, or both such steps. The illustrated embodiments represent both.

In an apparatus and method in accordance with the invention, a problem is addressed that relates to the decisions and execution of those decisions for maintaining, repairing, replacing, observing, testing, inspecting, or otherwise servicing infrastructure assets. As discussed hereinabove, infrastructure assets range broadly. Primarily, infrastructure assets, especially public infrastructure assets, represent various hardware components, systems, apparatus, devices, and entities that have an initiation of their life in construction, purchase, installation, or the like.

Following the capital expenditure for installation, each asset needs to be tracked, have records kept on it, and be serviced. Services include, for example, observation, testing, inspection, maintenance, repair, replacement, and so forth. These occur at various times during its serviceable life as an infrastructure asset. As discussed hereinabove, the underground, overhead, or otherwise remote and distributed existence of so many infrastructure assets, contributes to their inaccessible nature. This begs the question of why conventional methods are inadequate for their evaluation, judgment or classification, observation, testing, tracking, maintenance, repair, and so forth.

For example, when a water line bursts, it will typically cause sufficient havoc to gather attention. That attention immediately turns to remediation. Digging up a water line, sewer line, data line, communication line, or the like may provide an only or a best opportunity for observation and reporting of condition.

Regardless of the guarantee specified in a bidding process, or the warranty provided by a vendor or installer, the actual life of a particular asset of any type in an infrastructure system will be something else. Life may be longer or shorter than specified. Moreover, any periodic maintenance, repair, replacement, or the like will change the life of any particular component or system.

Thus, conventional practices of installing an infrastructure asset and then depreciating it along a manufacturer's or installer's predicted lifetime does not serve the service to customers by that asset. Moreover, it does not serve well the management and maintenance by the owner (for example, a city, and therefore the city government or management) responsible to maintain that asset.

Failure to properly manage infrastructure assets is or can be a hot political topic, and needs to be addressed. City governments that do not pay adequate attention to the inspection, maintenance, repair, and replacement of infrastructure assets are deemed irresponsible. Some decades past, for example, managers of an eastern U.S. city were accused of intentionally failing to report an outbreak of a water-borne, highly communicable disease being transmitted through the city water supply. Eventual disclosure of that information, including a boil order for water, and other protective measures were withheld until after the deadline by which citizens were required to pay certain municipal taxes and bills. The political fallout, though vociferous and emotional, seemed calculated. It nevertheless died down predictably over the following year. This was exactly what the political fathers had intended by their delay.

Meanwhile, tools to do so are not only less than rudimentary, they are largely speculative. Some express the opinion that manufacturer's statements of product life are simply not accurate. They are typically straight lined depreciation curves over some arbitrary period of life. Such curves do not account for maintenance in a quantified and accurate manner.

Manufacturers do not typically specify maintenance or inspections. Those functions tend to be site specific. Certain maintenance and repair procedures may substantially increase life of assets. Some assets will deteriorate in spite of maintenance, but still must be maintained in order to function properly throughout their useful lifetime.

Thus, a component or subsystem of a physical system 130 of interconnected infrastructure assets may need to be serviced, inspected, repaired, replaced, and so forth. An asset, whether at a time, in a region, in an event, or in response to failure, needs a response to deteriorating condition, performance metrics, or the like. The response should be in accordance with accurate modeling, predicting, and comparison. Here it may be according to a normalized comparison ratio (NCR) provided in a process in accordance with the invention.

Moreover, a method of service, including inspection, maintenance, repair, rebuilding, selective replacement, and so forth may be implemented in a method and system in accordance with the invention.

Referring to FIG. 11, while continue to refer generally to FIGS. 1 through 12, a process 238 in accordance with the invention may rely on various of the modules 150 illustrated in FIG. 6. For example, in any system 130 of infrastructure (see FIG. 4, for example), creation 240 of a subject infrastructure asset 132 will typically require a process of construction 242.

Construction 242 will typically require, as a matter of law and good engineering practice, planning 243a, permitting 243b, under the purview of a city or some political jurisdiction, installing 243c, inspecting 243d, and otherwise obtaining an acceptance 243d of the installed infrastructure component, system, network, or the like. Such a construction project 242 has its analog in virtually every type of infrastructure system 130. Whether data lines, other communication lines, culinary water lines, sewer lines, storm drain lines, streets, sidewalks, paths, gutters, green spaces, electrical power, or whatever, this process is effectively required.

Similarly, the scope of an infrastructure construction project 242 may range from an individual component, such as electrical box, a water valve, a length of line, a street cul-de-sac, or intersection, to a street lighting pole, an electrical transformer, and so forth.

In some embodiments, a construction project 242 may involve the entire development of a neighborhood. A developer may approach raw land with an onslaught of activity preparing ground, installing all types of infrastructure lines and components, even up to constructing personal infrastructure of houses and so forth for sale.

Following construction 242 public assets are typically turned over to new ownership. A developer builds a development, but turns over to the city all the infrastructure of the development including streets, water lines, sewer lines, and so forth. This creates a multiplicity of questions, problems, and concerns for cities as the eventual owners of that infrastructure.

For example, the city exercises some control by way of the inspections 243d, which are typically periodic during construction and finalized at some later point. These influence the quality of the workmanship, the components, and so forth. However, the eventual owner (e.g., the city, the county, the state, etc.) does not actually have a record of the manufacturer, the specific component, and so forth. There may be blueprints somewhere, but they are not typically reliable, available, or otherwise a tractable resource. Instead, the infrastructure is largely undocumented. Moreover, it has been found that one of the greatest variables in the longevity, maintenance, repair, and replacement of infrastructure assets is the installer.

Nevertheless, other factors do weigh heavily. For example, manufacturer's of particular hardware, the geologic makeup of the region, and terrain may affect life and condition. Weather damage and lightning strikes arise from terrain. Chemistry of the water supply may affect the lifetime, scaling, fouling, or corrosion of water lines and the like. All may work as factors in affecting the serviceable life and intermediate condition of any particular infrastructure asset.

In infrastructure assets one may include any item that costs money, requires service, provides a function, or otherwise goes into the support of a plant, whether an industrial plant of a company, or especially the physical plant of a village, town, city, metropolis, county, state, or the like. Thus, infrastructure assets are things. Actual things. They are not information alone. They need information to be maintained regarding them. However, they actually have physical presence and function. They are physical assets. They can be seen, but often not easily due to their remote locations, buried locations, or the like.

They can typically deteriorate over time. They often can be serviced regularly to extend their lives or improve their performance metrics. They may have to be repaired when acutely damaged. They may have to be repaired and replaced when they show chronic damage or deterioration. Typically, when the cost of maintenance exceeds the capital cost or replacement, it makes sense to replace failing assets. Nevertheless, there is often no way to do so reliably outside of a system and method in accordance with the invention.

Following construction 242, observing 246 may continue by one or several available methods. However, observing 246 is not always possible, often not simple, and frequently not easy. Therefore, observing 246 may necessarily be comparatively limited compared to equivalent observations of machinery and such assets that exist in factories and the like. Infrastructures often out of sight, it is often out of mind, but it can never be forgotten without consequences.

In a system and method in accordance with the invention, other activities related to infrastructure may be ongoing, or may be initiated in accordance with the invention. For example, manufacturer testing 250 may be an ongoing activity at some level. It may be simulated conditions for life testing, service testing, cycling, loading, or the like done in a laboratory. Some manufacture testing 250 may be outside the laboratory in environments analogous to service conditions of the asset. Also, periodic follow up testing 250 may also occur in situ by manufacturers seeking to evaluate products that are being inspected, maintained, repaired, or replaced in service.

Thus, manufacturer testing 250 may include collecting test data 251a. As a result of the test data 251a manufacturer testing 250 may provide recommended actions 251b. Similarly, by data 251a, by analysis, by inspection, by empirical information, by guess or by gosh, a life prediction 251c may be provided by manufacturer testing 250. Sometimes these have little support and unknown justification.

Analogously, expert systems 252 may be relied upon to provide data 253a, recommendations for action 253b, whether that action is periodic, episodic, event-centric, routine, on demand, or on whatever other basis. Likewise, expert systems 252 may provide predictions 253c. Predictions 253c may be based on comparatively rigid, deterministic, scientific analysis of data 253a.

Typically, expert systems 252 will rely on computer programming that seeks to embody certain physical, objective data with the almost intuitive diagnostic abilities of experts in the field. Experts' experience allows them to analyze and otherwise navigate and analyze complex sets of circumstances into recommendations 253b or predictions 253c that may not be readily discernable strictly analytically.

In addition to the foregoing, extra-systemic analysis 254 may be based on field data 255a from other installations outside of the infrastructure 130 that is the subject of the creation 240 or construction 242. To be completely accurate, any creation 240 of a subject infrastructure asset may involve construction 242 or installation 242 of a single component, a system of interconnected components, or a wide-ranging, geographically distributed system of interconnected combinations of components.

For example, a single water hydrant, a single valve, a single transformer, a single data hub, or the like may be considered an asset. Likewise, a system 130 that is the subject of a creation 240 may be a neighborhood, a town, a building development, or the like. Thus, it is proper to speak of an infrastructure asset, which asset may be defined at any suitable degree of granularity. That is, an “atomic level” asset is typically a single component. However, single components 132 may be agglomerated into subsystems or systems as atomic units of some larger infrastructure system 130.

Accordingly, one may think of a system 130 as that of one jurisdiction, and typically in one region under consideration. That is to say, cities are built in neighborhoods. Neighborhoods grow up over time periods, but begin at a time, and most of the work therein as to construction 242 or installation 242 of infrastructure assets occurs during a limited period of time. However, these little “micro-booms” of construction 242 may occur at effectively random times. A developer, a population, and an economic situation provide the necessary constituents to create a construction project.

Thus, the extra-systemic analysis module 254 or process 254 obtains field data 255a outside of the system 130 under consideration. Therefore, any analyses 255b, such as correlations 255b, models 255b, or the like relate to extra-systemic assets not within the system 130 under consideration.

Therefore, another source of analysis 255b and predictions 255c may be found in infrastructure systems outside the specific system 130 under consideration. One can see that the method 238 or process 238 may gain information from a particular system 130 under consideration, based on the records 248 and analysis 262 of that system 130. However, in a system and method in accordance with the invention, additional sources of information may also be added from manufacturer testing 250, expert systems 252, and extra-systemic analyses 254.

In a system and method in accordance with the invention, a controlled service system 256 may include, for example, the illustrated constituents and others. Typically, an array of modules may include a prediction module 258 or a prediction step 258. The prediction module 258 may rely on the records 248 from the subject system 130, as well as records of data 251a, 253a, 255a, recommendations 251b, 253b, correlations 255b and other analyses 255b, as well as predictions 251c, 253c, 255c establishing expectations 251c, 253c, 255c.

Necessarily, the data 251a, 253a, 255a may not all be equal in value, reliability, accuracy, and so forth. Likewise, the records 248 from the observations 246 may be some of the most pertinent as they actually pertain to the system 130 under consideration. However, part of the problem with infrastructure management, observation 246, records 248, inspections 243d, maintenance, repair, and replacement is time delay and the very rarity of early data 248. Infrastructure systems 130 may be installed and operate virtually flawlessly and without much attention for decades.

However, at some point, with aging, come deterioration and periodic reductions in the values of performance metrics 165 or key performance indicators 165. Waiting for a failure is not a plan for proactive maintenance and other service. Therefore, records 248 relating to service calls, repair, maintenance, inspections, and the like may be very valuable, and should be maintained. However, manufacturer testing 250, although shown to be very gross and highly unreliable, still represents information.

Also, expert systems 252 are based on experienced experts. The computerization of that knowledge is embodied in programs that can make decisions based on the simpler programming logic built around often sophisticated and complex expert knowledge. Thus, such systems and processes can be very useful.

Similarly, extra-system analysis 254 from similarly situated systems may have similar loads, similar materials, similar geography, climate, operational characteristics, and so forth. These may be extremely valuable, as they provide, or can provide, decades of data decades in advance for use in the controlled service system 256 in accordance with the invention.

In a system and method in accordance with the invention, a comparison 260 may be executed by a comparison module 260 based on an analysis 262 by an analysis module 262 and a prediction 258 from a prediction module 258. The analysis module 262 operates on the data 248 or records 248 from the subject system 130. Thus, manufacturer testing 250, expert systems 252, extra-systemic analysis 254, and other analyses on a similar basis are provided into and used by the analysis module 264. The analysis module 264 provides an analysis of life and service as a function of any number of parameters that can be identified, quantified, measured, recorded, and therefore submitted for analysis 264.

In contrast, the prediction module 258 provides its expectations or predictions 258 from analysis 264 outside the subject system 130. By modeling according to any one of several systems and methods described hereinbelow, as well as those hereinabove, a prediction module 258 may provide an expectation 258 or a prediction 258 against which the comparison module 260 may compare results of the analysis 262.

Ultimately, the comparison module 260 provides recommended actions 266. A recommendation module 266 may incorporate other factors outside of the analyses 262, 264. For example, time, timing, budget, other plans not of record in the process 238, or the process 256, and the like may be considered. Also, the recommendation module 266 may consider and evaluate based on programming to decide according to priorities.

Likewise, the recommendation module 266 may recommend actions based on the improvement in a maintenance score or condition score of an asset, a system of assets, or an entire infrastructure system 130. These may also be based on the best improvement in condition or return on investment.

Similarly, various weights or weighting processes may be programmed into the models for prediction 258. These may account for the penalties on inconvenience, cost, and valuation of risk for catastrophic failures. Thus, various priorities may be established by weighted coefficients or weighted values or calculations of risk, cost, convenience, political capital (reputation, election cycles, etc.), and other factors that may go into decisions.

For example, current practice treats infrastructure assets as capital expenditures having a life that extends along a depreciation schedule. Depreciation occurs along some number of time units, such as years. Typically, a straight line degradation or degeneration (depreciation) curve represents life from the day of installation to some theoretical date of total demise.

Waiting for total demise is not a strategy. However, what is a strategy? Manufacturer's predicted lifetimes, are often not even based on manufacturer testing 250. Sometimes, they may be based on certain laboratory tests that are nevertheless not reflective of reality. Such “life estimates” do not figure in the maintenance operations and their effects. This often may cause a city or other owner of infrastructure assets to replace equipment that is completely serviceable for decades hence.

In a system and method in accordance with the invention, a recommendation module 266 provides recommendations 266 or recommends 266 various services 268. As described above, the schematic may represent the executable, the step, or the result. The entire rationale behind recommendations 266 of services 268 may encompass many factors. Some of those factors come from the analyses 262, 264. Some result from the prediction 258. Certainly some should now come from the comparison module 260. The analysis 264 underlying the recommended actions 266 and the processing by the comparison module 260 and by the recommendations module 266 should accommodate all the factors that can be programmed into them.

Meanwhile, service 268 may be directed by several motivations. The most urgent recommended actions 266 may be responses to asset failures. A broken water main needs to be repaired immediately. Cost is almost not an object. City infrastructure must operate or the city does not operate. However, next in urgency may be some threshold level of function driving repairs or repair costs.

For example, a catastrophic and acute emergency may require immediate repair, replacement, or the like. However, degraded performance may require some other type of service. Similarly, a degradation of functionality may be addressed by some minor service such as cleaning, minor repairs, or the like. However, yet other types of service 268 may be introduced in a system and method in accordance with the invention.

For example, service 268 should also include certain inspections. This contemplates video inspecting, sampling, selectively, including intentional digging out, even possible intentional destructive testing, and the like. These would typically not be available or relied upon in conventional systems and processes. Thus, service 268 coming from the recommendation module 266 may be based on urgent and catastrophic failures, chronic or continually degrading performance, objective performance degradation metrics, or the need for data otherwise in the records 248.

Routine service 268 may be specified according to the recommendations 266. The comparison module 260 detects excess services as well as inadequate services, in order to both improve needed services and reduce routine, ubiquitous, marginally valuable inspections. Thus, resources may be allocated more efficiently and effectively to provide the best recommendations 266 for services 268.

Any service 268 should be reported 270. Reporting 270 may be directed by computerized systems that record information, including objective, numerical, physical data, judgments by inspector's, and so forth. Ultimately, a test 272 should determine whether the infrastructure asset in question has an acceptable life. If so, then the service 268 should have returned it to service, and may have improved its expected life. The test 272 may result in more records 248 including the reports 270. New analyses 262, 264 may continually re-evaluate and re-predict 258 the life of the asset.

One will note that the records 248 are also included in the analysis 264. As more data becomes available and more records 248 become within the subject system 238, the analysis 264 may be based on actual systemic data for the system 130 of assets 132. However, there may always be a place in the analysis 264 and the prediction 258 for manufacturer testing 250, expert systems 252, extra-systemic analysis 254, and other sources of data. The system 238 and method 238 benefit from any available data 248, 251a, 253a, 255a, analysis 262, 264, predictions 251c, 253c, 255c, 258, and inclusion of any factors useful for prediction 258.

On the other hand, if, for example, a service 268 is designated as or intended to be a repair or replacement, it may be truncated to a minor inspection. This may be due to the test 272 adjudging the asset to have an unacceptable life 272. Then a test 274 may determine whether to replace the asset. If the asset is to be replaced, then some level of planning 243a, permitting 243b, installing 243c, inspecting 243d, and operating 244 may follow.

However, in looking at a system 130 under consideration, it may be that the test 274 indicates replacement is not an option. In that case, the component or system life may come to an end 276. At this point, the subject component or system 130 may be destroyed, abandoned, completely dug up and replaced, or otherwise begun with a new plan 243a for creation 240 and construction 242.

Referring to FIG. 12, while continuing to refer generally to FIGS. 1 through 12, a process 280 in accordance with the invention may include a variety of intermediate modules, steps, or the like. For example, the analysis module 262 and the analysis module 264 represent those activities or steps in the overall process 238, and the sub process 256, as well as the internal process 280. However, each 262, 264 also represents an executable module 262, 264 conducting those functions. Thus, each may include a statistical module 282.

Herein, any reference numeral having a trailing letter is merely a specific instance of that numeral and has been mentioned, even without specific reference to its letter. Thus, we may speak of a generic element 282, and discuss the differences between specific instances 282a, 282b. Here, for example, the statistical module 282a relates to analysis of the subject system 130. In contrast, the statistical module 282b within the analysis module 264 relates to one or more of the manufacturer testing 250, expert systems 252, extra-systemic analysis systems 254, or other systems.

Meanwhile, the statistical modules 282 represent statistical analysis based on statistical data available from the source records 248 and other data 251a, 253a, 255a. Similarly, the statistical modules 282 may also incorporate at some level, or on some basis, some of the analytical predictions 251c, 253c, 255c. Typical statistical analyses may include self sampling, system sampling, wide area system sampling. It may involve various types of curve fitting of data.

For example, various regression analyses, whether linear, non linear, or multi variant may be used. Similarly, curve fits such as least squares, linear least squares, non-linear least squares, and other weighted equations solved by matrix algebra such as linear or non-linear system solvers for arrays of variables from multiple equations or differential equations may be relied upon. Typically, however, the statistical engines 282 or modules 282 will rely on statistical analysis to establish information, relating lifetime and serviceability parameters or performance metrics to various activities by way of inspections, evaluations, maintenance, repairs, replacements, and so forth.

Similarly, “numerical methods” or “numerical analysis” systems may be embodied in the numerical modulus 284a, 284b. Numerical analysis is an entire engineering field of its own. For example, numerical methods are used to solve by computer approximation insoluble systems of equations. For example, certain relationships may be known, hypothesized, suspected, estimated, or postulated between some performance parameter and one or more factors or independent variables. However, some relationships do not bow to deterministic mathematics. Numerical methods or numerical analysis is that field of engineering that seeks to solve systems of equations, describing physical systems, that have no solution. Therefore, with the advent of high speed digital computers, numerical methods may be used to approximate solutions to insoluble equations. This may result in analyzing data to fit curves to it. It may include modeling, based on relationships and data, to predict curves for behavior. Thus, the numerical modules 284 may be used to do analysis. They may also be used in the prediction modules 251c, 253c, 255c, 258.

Empirical modules 286a, 286b incorporate empirical or directly available test information. One may think of statistical data as being empirical in nature. However, by empirical modules 286 is meant modules 286 that are going to rely directly on empirical information available.

For example, in a comparatively new system 130 under consideration, virtually no actual empirical data exists. Therefore, the effect of an empirical model 286a initially will be virtually nil. However, the empirical module 286b may be so well established that all of its information is already handled by the statistical module 282b and numerical module 284b.

However, in general, an empirical module 286 here represents a module 286 processing specific experiential data be tied to specific observations or experiments. It is therefore often entitled to greater weight, greater consideration. It may have better correspondence between the input (independent) variables, and the output (dependent) variables.

Finally, a historical module 289a, 289b may serve as a handler for all types of historical information. For example, the historical module 289 may be responsible to parse text records in order to try to mine numerical data from them. Also, historical information may be found in legacy reports. Text may also be reviewed by and factored into expert systems 252.

Historical information may be available to the historical module 289 from experts, inspectors, books of guidelines, rules of thumb, and so forth. Thus, the historical module 289 may be set up to process by data mining, analysis, and so forth, information that pertains to the history of a system subject to the analysis 262, 264. In some respects, all statistical data and empirical data is in some respect historical. However, by historical data is intended that data which is mainly an artifact of the history of the services 268 related, directly or by analogy or similitude, to systems, and which goes beyond the strict numerical data otherwise available. Thus, expert analysis, inspection reports, text reports, and the like may add insight that gives greater or lesser weight to other information handled by the other modules 282, 284, 286, 288, and so forth.

In the illustrated embodiment, the prediction module 258 may include various factors 298 or processes 298. Such processes 298 are far too numerous to mention. Entire books are written on modeling, numerical analysis, curve fitting, and so forth. Thus, a mere sample 298 of methods 298 is illustrated.

For example, the least squares fits are used to fit data. However they may also thereafter be used to predict performance based on the dependent and independent variables that are used in the least squares fit. Similarly, other regression analysis may do the same. Polynomial fits are typically used in numerical methods for exact fitting or even in the least squares methods. A polynomial fit may be used to fit limited data exactly, or to fit statistical data with a lower order polynomial than an exact fit. This will order to smooth out any internal anomalies, oscillation in the solution, and so forth. However, a polynomial fit may serve well as a predictor because it may provide dependence multiple variables, or multi-dimensional analysis outside its range of data.

Similarly, predictor-corrector methods provide for modeling, followed by feedback and correction of the model. Also, shooting methods provide for using past data to predict future data by numerical methods of extrapolation beyond the base of data available.

In certain situations, solutions of simultaneous equations of variables may be used. For example, an expert may believe or understand that certain independent variables are functions of certain dependent variables. A system of equations may be written whereby the number of unknowns is represented in that number of simultaneous, independent equations. The equations may then be solved or numerically approximated for values of the coefficients. Thus the result predicts or assigns relative influences of each of the independent variable terms.

Such systems of equations may be non-linear, coupled, and otherwise include higher orders than one for variables. In fact, certain numerical methods exist, such as Newton's method for the solution of simultaneous systems of non linear (coupled) partial differential equations. Such equations have no closed form solutions. They are simply impossible to solve. However, computers permit approximations to solutions to within sufficient precision to answer most engineering questions.

Thus, various methods may be used, and each of the foregoing and subsequent methods discussed herein are not necessarily completely independent, but many operate together. Meanwhile, various other numerical methods or numerical analysis techniques may be used. Also, extra systems may provide for weighted additions, weighted multipliers, or weighted coefficients according to expert analysis for the reliability or significance of variables.

For example, a curve fit may use weighted coefficients in front of variables in one of the methods hereinabove. Likewise, a weighted average may be used to take data that should be effectively stating the same fact, and having differing values, in order to determine to what extent each source will be relied upon.

Meanwhile, other modeling techniques may also be used. By whatever mode, the prediction module 258 may provide a prediction 258 or expectation 258 for the comparison module 260. Ultimately, in the absence of data from actual installations over some period of life, laboratory data may be the best available. In other words, manufacturer testing 250 may provide its test data 251 as the only model available for prediction 258. Likewise, an expert or multiple experts relied on in an expert system 252 may accumulate data 253a, explicitly or implicitly over a period of time. The expert system 252 may thus provide recommendations 253b that result in predictions 253c. These may serve as that initial prediction model 298. By whatever mode, a prediction 258 needs to be provided in order to get a first order evaluation 260 and recommendation decision 266 of the activities of service 268 to be conducted.

In fact, in certain embodiments, one may conduct the analysis 262 on the set of expected values, and later perform the analysis 262 on actual values. One could literally vote among knowledgeable experts on values for independent variables and their influence, and of values of dependent variables resulting therefrom. Coarse curve fits, rudimentary curve fits, straight lines, or the like may all be used. Time and data 251a, 253a, 255a and 248 eventually improve both the prediction 258 and the comparison 260 from the analysis 262.

One valuable analytical tool is the normalized comparison ratio 290 (NCR 290). In this NCR module 290, a computer compares an actual value 292 from the analysis 262 against a predicted value 294 provided by the prediction 258. The values 292, 294 may relate to any measurable parameter of influence. Some values may include a service type or service class reduced to a numerical value.

For example, replacement is a high value operation. On an order of magnitude of 100 it compares to an inspection at an order of magnitude of maybe five. Meanwhile, a maintenance task may have an order of magnitude of 10 or 20. Repair may have an influence of from about 20 to about 70 compared to total replacement at a value of about 100. These numbers are simply examples of relative valuing of events.

Similarly, financial numbers are usually available because budgeting is such a ubiquitous practice. The actual value 292 of expenditures on any given individual component, subsystem, or system may typically be extracted from budget values. Meanwhile, a predicted value 294 for expenditures may come directly from the manufacturer testing module 250. Thus, actual expenditures 292 compared to predicted expenditures 294 will give an immediate indicator of whether expenses are above or below predicted expectations 294. This may implicate a need for more or less service 268.

In yet another comparison, the normalized comparison ratio 290 may relate any value of any parameter to the predicted value thereof. For example, a service type or class may be a variable, having some weighted value representing an order of magnitude of influence. Similarly, the time since the last service is a value. The total number of service incidents, the total number of service incidents of a particular type, or the like may be used as a parameter for a value 292, 294.

Similarly, a frequency of routine service may be used. The largest time gap between services or an average time gap between services of any particular type may be used. The mean time between failures, the mean time between service, the mean down time for each call, the maximum down time, and such factors are all valuable in the information they provide.

For example, the amount of uninterrupted time in service, the number of downtime incidents, the typical amount of time or the maximum and minimum amounts of time that a system or component is down for service, and so forth are valuable parameters. Likewise, are durability, longevity of total life before replacement, a maximum and minimum thereof, and so forth. These may all be used as parameters in an NCR 290.

Even service 268 that only represents observation or inspection may still be used. For example, the time since last observation, the total time between observations on average, the change in life over each period of time as observed, the weight or significance of changes in functionality or serviceability, the frequency of observations, the total number of observations, and the like may all be considered.

Meanwhile, a curve of condition as measured or estimated upon inspection may be compared at any point against a predicted curve of condition based on any of the prediction module's 258 predictions, and underlying analysis 264 and data 251a, 253a, 255a. By normalized is meant that the units of the value 292 are the same as the units of the value 294. Thus, years are compared with years. Condition is compared with condition. Lifetime is compared with lifetime. Wall thickness is compared with wall thickness. Flow rate is compared to the flow rate.

Any value 292 that is to be measured as an actual value 292 is normalized against a predicted value 294 of the same parameter in the same units. This immediately provides an ability by the computer to evaluate whether any system 130 or component 132 thereof is performing to expectations. It may also tell in a dollars-to-dollars comparison, a normalized ratio or NCR 290 of expenditures by component, by subsystem, by system 130, or the like. Comparisons may also be done against other extra-systemic infrastructures incorporated into the analysis 254.

A summation normalized comparison ratio 296 (SNCR 296) may also compare a summation of values (corresponding to events) to expectations for those events. These may or may not be weighted. Thus, a summation may show an overall system normalization. The units in any given term may match, but the individual units from term to term may be strictly in terms of dimensionless ratios of NCR's 290. Thus they provide a broader SNCR 296 reflecting more than an individual NCR 290 might reflect.

In certain embodiments, an event ratio 290a may simply provide an NCR 290 for a particular event. For example, a replacement, a failure, a repair, a maintenance, an inspection, or the like may have some characterization. Such events may be characterized by the total number, their periodicity or time between events, their frequency throughout some time, the expenditures on each, and so forth. Any of these numbers might be used to create an event ratio 290a that is a specific example of an NCR 290 applied to a single event, rather than a single system. Not only that, a type of event, such as service calls for cleaning fire hydrants may be compared across all the fire hydrants within a subject system 130, and thus provide an event ratio 290a for the effectiveness, cost effectiveness, and more for specific types of events.

By the same token, a life or persistence ratio 290b may involve such things as duration, which amounts to lifetime or life between events. Similarly, expenditures, condition, typically rated as remaining life or used up life, or the like may be used in a life ratio 290b. Likewise, depreciation schedules may or may not be directly related to actual life remaining.

Until now, no mechanism existed to determine the appreciation of an asset as a function of repairs, maintenance, or the like. In the past, an infrastructure asset (apparatus, device, thing) has been treated as a capital expenditure depreciated over some nominal lifetime dictated by a manufacturer testing 250 or simply manufacturer warranty. The warranty may have little bearing on reality.

For example, one manufacturer of utility equipment used by public utilities provided a 20 year warranty for decades. However, the typical lifetime of the utility asset was typically over 50 years. Thus, a depreciation over 20 years may help with capitalization, but is actually unrealistic for services 268. Thus, following a depreciation schedule or setting a depreciation or condition schedule according to a warranty might have no relationship to reality.

Moreover, whenever maintenance or repair is done, that maintenance or repair may be significant. Re-lining a pipe effectively rebuilds it, even though it does not actually replace it. Sealing is similar, but less durable. However, all the replacement costs of digging and burying again do not recur. Such a maintenance operation may be so significant that it represents a capital cost. Yet, the capital cost does not reset the depreciation schedule or condition degradation schedule of an asset. Thus, here, the life ratios 290b or persistence ratios 290b represent a reset on the life expectation and the actual life estimate and observation as a result of service.

Ultimately, whichever NCR 290 is calculated, by a system and method in accordance with the invention, recommendations 266 may occur as a result of other priorities too numerous to list. For example, a city may be concerned about budget, lifetime, performance, service, maintenance, reliability, or the like. Meanwhile, city governments and management may be concerned with expenditures, and the allocation of those expenditures at a proper rate to maintain infrastructure.

Thus, when the NCR 290 falls below the normalized value of one, or unity, actual events, performance parameters, expenditures, or the like are not those predicted. This raises the question of whether the prediction needs to be improved, or whether the expenditures need to be raised. However, the recommendation module 266 may provide for various recommendations (according to weights, priorities, and the like) including remediation, by certain events of inspection, maintenance, repair, replacement, or the like. Likewise, the remediations 300 may come out as rates of the occurrence of events. Similarly, according to financial or security and reliability factors, various priorities may show up to be used in the recommendation module 266 to recommend actions and a priority or sequence of activities 268 or services 268.

When an asset has a useful life less than some arbitrary percent, it may be scheduled for replacement. Alternatively, periodic failures, ongoing deterioration effects, and the like may begin to cause maintenance and service operations to become too costly. Alternatively, when maintenance costs begin to dwarf capitalization costs, an infrastructure asset, whether component or subsystem, may be replaced.

Any ability to inspect is limited and expensive. Any conventional prediction is highly inaccurate, obedience to it, costly, its basis very suspect, and all are largely without objective justification. By prediction modeling, computerized information is incorporated from a subject component or system, but also various similarly situated components and systems for which actual data is available.

Operation, maintenance, repair, and deployment of equipment, infrastructure assets, machines, devices, apparatus, fixtures, and the like is controlled on an analytical basis or predictive basis, founded on predicted actual life. Controls are applied to procedures, methods, activities, and equipment.

Every tool may be known from adjustable end wrench, through hammer, box end wrench, open end wrench, pipe wrench, screw driver, drill, grinder, punch, chisel, hex wrench, specialty wrench, nut driver, shears, press, box angle bender, boring machine, tractor, compactor, roller, street sweeper, cutter, welder, jig, compressor, impact wrench, puller, saw, and on and on. By identifying every tool-type asset, whether identified as hand tool, power tool, machine, or whatever, the location, disposition, assignment, operation, and task to which applied may be defined therefor by a system in accordance with the invention.

Personnel may also be known, identified, assigned, tracked, reported, and otherwise applied. Actions may be defined and associated with a machine, a person, a location, an asset, or the like. Consumable materials, parts, components, or the like may also be identified, assigned, applied, and reported. All these will necessarily have costs associated with them, which may typically be linked to their respective, corresponding data in a database.

The result is a system and method of devices and entities that operate together under unified control as a controlled system on a much broader scale than a small, self-contained device at a single location.

The present invention may be embodied in other specific forms without departing from its purposes, functions, structures, or operational characteristics. The described embodiments are to be considered in all respects only as illustrative, and not restrictive. The scope of the invention is, therefore, indicated by the claims, rather than by the foregoing description. All changes which come within the meaning and range of equivalency of the claims are to be embraced within their scope.

Wherefore, we claim:

1. A system for maintaining components of infrastructure, the system comprising:
a collection of tools, each shaped and sized to physically operate on at least one asset of a plurality of assets composing an infrastructure of interconnected and interrelated physical objects, each physical object thereof forming at least a part of a corresponding asset of the plurality of assets;
a computer system comprising at least one processor operating as a computing device, and at least one memory device operably connected thereto and operating as storage for data processed by the processor;
the at least one memory device storing inspection data reflecting a condition of each asset of the plurality of assets;
the at least one memory device storing executables comprising an analysis module providing analyzed data, based on the inspection data corresponding to a set of assets from the plurality of assets, a prediction module determining prediction data projecting performance of the set of assets, and a comparison module providing a comparison based on comparing the analyzed data to the prediction data; and
the computer system programmed to select a selection of the tools and operators therefor to operate on the set of assets, based on the comparison.

2. The system of claim 1, further comprising:
the computer system, further programmed to define types of the assets, each type corresponding to a component constituting a structure having a function and physical characteristics reflecting the ability of the type to accomplish the function.

3. The system of claim 2, wherein the computer system is further programmed to select life parameters reflecting operational life remaining each of the respective types.

4. The system of claim 3, wherein the
computer system is further programmed to determine for each of the types, a life value corresponding to the each of the types within the plurality of assets and respective life parameters corresponding thereto, individually.

5. The system of claim 1, wherein the computer system is further programmed to calculate a condition score for at least one of each asset and each type, the condition score reflecting the life value representing remaining operable service life.

6. The system of claim 5, wherein the computer system is further programmed to calculate the condition score based on an inspection and another predicted data based on another assessment independent thereof.

7. The system of claim 6, wherein the computer system is programmed to calculate a normalized comparison ratio reflecting, at least one of a maintenance score and a condition score relative to a predicted life score of an asset of the plurality of assets.

8. The system of claim 7, wherein the computer system is programmed to provide a predicted life of the asset based on an integrated score reflecting an expected operational lifetime of a subject component and independent information not originating with the asset itself.

9. The system of claim 8, wherein:
the inspection data represent a physical condition observable by at least one of a sensor, electronic communication device, visual observation; and destructive testing; and
the plurality of maintenance events is selected from the group consisting of measuring, adjusting, exposing for visual inspection, cleaning, repairing, replacing, refurbishing, and modifying.

10. The method of claim 9, wherein inspection prediction data correspond to at least one of:
analysis of the asset, based on a visual inspection;
analysis of the asset, based on measurable physical properties thereof;
analysis of a comparative component situated similarly to the asset;
an expert opinion independent from the asset; and
analysis of destructive test data corresponding to a removed component of the same type as that of the subject component.

11. An article of manufacture effective to control a system for maintenance of an infrastructure made up of assets comprising components having physical properties and dimensions, the article including a computing system comprising at least one processor operably connected to a memory, wherein the memory is constituted as a non-transitory, computer-readable memory device storing data structures constituting operational data and executables, the executables constituting instructions executable on the at least one processor for operating on the operational data, and the data structures comprising:
records corresponding to assets in the infrastructure, each asset being a component thereof;
a database linking information to geographical positioning of the assets and storing data reflecting attributes corresponding to the assets;
a prediction module executable on the processor to calculate a predicted life projecting remaining operating life of a subject component of the components in the infrastructure;
an analysis module programmed to instruct the processor to calculate an actual life remaining, based on the actual condition of the subject component; and
a comparison module programmed to determine a service for the subject component, based on comparing the actual life to the predicted life.

12. The article of claim 11, further comprising at least one of:
a history module responsible for gathering, maintaining, and otherwise handling historical information;
a similarity module responsible for gathering historical information and linking information that relates assets similarly situated and the attributes corresponding thereto;
a management module responsible for intake, storing, indexing and retrieving the records;
a scoring module comprising a maintenance scoring module programmed for determining a maintenance score for each of the assets by analyzing the effect on the respective lifetimes of the assets based on maintenance events corresponding thereto.

13. The article of claim 12, wherein the scoring module further comprises a condition scoring module programmed to receive inputs and calculate, based thereon, condition scores associated with the plurality of assets.

14. The article of claim 13 wherein the scoring module is programmed to determine a projected lifetime of a selected asset of the plurality of assets based on evaluating both the condition scores and the maintenance scores.

15. The article of claim 11, wherein the scoring module is further programmed to integrate the condition score and maintenance score with a financial analysis comparing continued maintenance with replacement of the components.

16. A method of maintaining physical objects identified as assets of a plurality of assets in an infrastructure of a plant, the method comprising:
identifying, by a computer system comprising at least one computing device, a plurality of types, each type corresponding to a structure having physical characteristics and a function as a component in an interconnected infrastructure of components;
selecting life parameters reflecting conditions corresponding to the types and corresponding to operational life of the types;
creating, by the computer system, a life value corresponding to the life parameters, by analyzing data reflecting a physical status corresponding to at least one of the types and instances of components of the types;
creating for each type, by the computer system, at least one of a condition score and a maintenance score, reflecting a lifetime for the each type, based on at least one of an inspection, and a prediction of the lifetime, not dependent on the inspection alone; and
determining, by the computer system, a comparison of the lifetime and the prediction, based on the prediction and at least one of the condition score and the maintenance score; and
dispatching equipment and operators for maintenance in accordance with the comparison.

17. The method of claim 16, further comprising analyzing effects of attributes on at least one of cost and maintenance, wherein the attributes are selected from location, type, dimensions, area, a region or district of responsibility, soils, climate, topology including connections, topography including elevation and geography, geology, materials, dates, ages, manufacturers, event history, workers who have accessed the asset, assessments by those who have worked on or accessed the assets, records, links, loads, flows, chemistry of contents of surrounding environments, traffic, times, seasons, identifiers, capacities, use cycles, duty cycles, vendors, installers, condition from inspections and reports, costs, condition scores, maintenance scores, and integrated scores based on condition scores and maintenance scores.

18. The method of claim 17, wherein the plurality of assets includes lines, pipes, fittings, fixtures, controls, connections, cables, poles, equipment, roads, canals, drainages, accesses, crossings, streets, trees, plants, buildings, ports, pumps, facilities, walks, signs, and other physical structures in at least one of a city and an industrial plant.
